(19) United States
(12) Patent Application Publication
(10) Pub. No.: US 2011/0054968 A1
(43) Pub. Date: Mar. 3, 2011

(54) CONTINUOUS PERFORMANCE IMPROVEMENT SYSTEM

(76) Inventor: Fernando V. GALAVIZ, McLean, VA (US)

(21) Appl. No.: 12/793,937

(22) Filed: Jun. 4, 2010

Related U.S. Application Data
(60) Provisional application No. 61/184,025, filed on Jun. 4, 2009.

(51) Int. Cl. G06Q 10/00

(52) U.S. Cl. 705/7.28; 705/7.41

(57) ABSTRACT

Disclosed is a system for continuous performance improvement. The system can include a web-based workspace module adapted to provide visibility of project documentation and to provide collaboration and version control for the project documentation, the web-based workspace further adapted to provide a corporate portal. The system can also include a project performance management module adapted to provide an assessment of current project performance against project-unique performance metrics. The system can further include a contract deliverable management module adapted to provide a report of project deliverables along with a delivery status of each project deliverable, and a financial reporting module adapted to provide financial reports representing project financial status. The system can also include an a customer satisfaction assurance module adapted to receive self assessment information and client feedback information related to performance on the project and to provide a report indicating customer satisfaction as represented by the self assessment information and the client feedback information.

### RELATED APPLICATIONS

This application claims the benefit of U.S. Provisional Application No. 61/184,025 filed Jun. 4, 2009, which is incorporated herein by reference in its entirety.

### FIELD OF THE INVENTION

Embodiments of the present invention relate to a system for continuous performance improvement. Specifically, one or more embodiments relate to a computer system, computer implemented method and computer-readable medium for managing, evaluating, motivating and obtaining continuous performance improvement.

### BACKGROUND

Projects typically involve numerous stakeholders having interests that may be different, but aligned for achieving a common objective related to the project. Stakeholders can include an end user or customer that commissions or requests the project be performed, a project management group that develops and monitors performance objectives of the project, a contractor team group that performs work on the project, and a contractor corporation or other entity that provides management oversight and support for the contractor team.

The various stakeholders associated with a project may be co-located or geographically disperse and/or associated with the same or different organizations. The stakeholders may be a homogenous group or a heterogeneous group composed of governmental entities, for-profit entities, not-for-profit entities, or a combination of the above.

Due to the often complex and distributed nature of modern projects, there may therefore be a need for a continuous performance improvement system that includes provisions for stakeholders to collaborate, define and manage risks, define and manage outcome expectations and provide output work products, reports and information related to project performance.

### SUMMARY

An integrated management approach to employee productivity and quality assurance for implementing and sustaining superior work-related services and support to civil and government clients. The system and method are based on a combination of techniques, training and software that are designed to: (A) Motivate employees to performance goals; (B) Achieve continuous performance output and capabilities; (C) Stimulate initiatives, creativity and innovation in the workplace; (D) Increase personal efficiency; (E) Provide objective analysis and feedback; and (F) Provide secure work environments.

The software systems can include: Factor-Driven Risk Methodology; Integrated Team Web-based Workspace; Performance Management Systems and Tools; and Customer Satisfaction Assurance Process.

One embodiment includes a system for continuous performance improvement. The system has a web-based workspace module adapted to provide visibility of project documentation and to provide collaboration and version control for the project documentation, the web-based workspace further adapted to provide a corporate portal; and a project performance management module adapted to provide an assessment of current project performance against project-unique performance metrics. The system also has a contract deliverable management module adapted to provide a report of project deliverables along with a delivery status of each project deliverable; and a financial reporting module adapted to provide financial reports representing project financial status. The system further has a customer satisfaction assurance module adapted to receive self assessment information and client feedback information related to performance on the project and to provide a report indicating customer satisfaction as represented by the self assessment information and the client feedback information.

Another embodiment is a computer-implemented method for continuous performance improvement, the method includes providing visibility of project documentation and permitting collaboration and version control for the project documentation, via a web-based workspace module, the web-based workspace further adapted to provide a corporate portal; and managing project performance using a project performance management module adapted to provide an assessment of current project performance against project-unique performance metrics. The method also includes providing a report of contract deliverables using a contract deliverable management module adapted to provide a report of project deliverables along with a delivery status of each project deliverable; and providing financial reports using a financial reporting module adapted to provide financial reports representing project financial status. The method further includes receiving self assessment information and client feedback information related to performance on the project at a customer satisfaction assurance module and providing a report indicating customer satisfaction as represented by the self assessment information and the client feedback information.

There has thus been outlined, rather broadly, certain features of exemplary embodiments in order that the detailed description thereof that follows may be better understood, and in order that the present contribution to the art may be better appreciated. There are, of course, additional features of the invention that will be described further hereinafter.

In this respect, before explaining at least one exemplary embodiment of the invention in detail, it is to be understood that the invention is not limited in its application to the details of construction and to the arrangements of the components set forth in the following description or illustrated in the drawings. The invention is capable of other embodiments and of being practiced and carried out in various ways. Also, it is to be understood that the phraseology and terminology employed herein are for the purpose of description and should not be regarded as limiting.

As such, those skilled in the art will appreciate that the conception upon which this disclosure is based may readily be utilized as a basis for the designing of other structures, methods and systems for carrying out the several purposes of the present invention. It is important, therefore, that equivalent constructions insofar as they do not depart from the spirit and scope of the present invention, are included in the present invention.

For a better understanding of the invention, its operating advantages and the specific objects attained by its uses, reference should be had to the accompanying drawings and descriptive matter which illustrate preferred embodiments of the invention.

### BRIEF DESCRIPTION

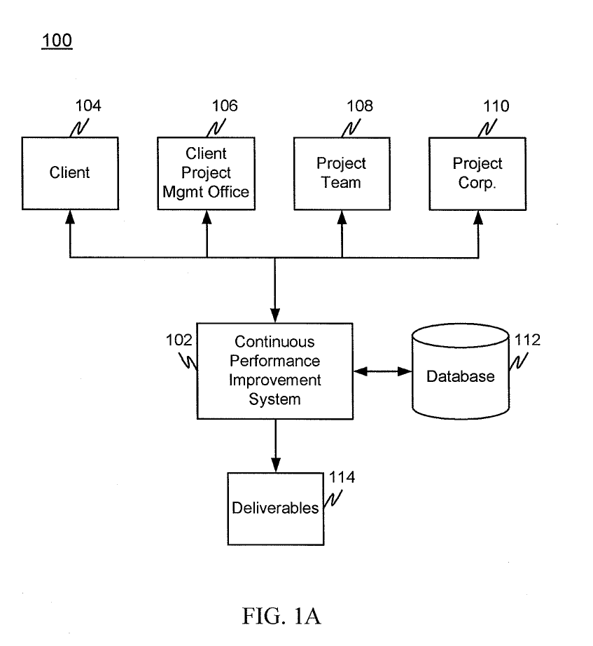

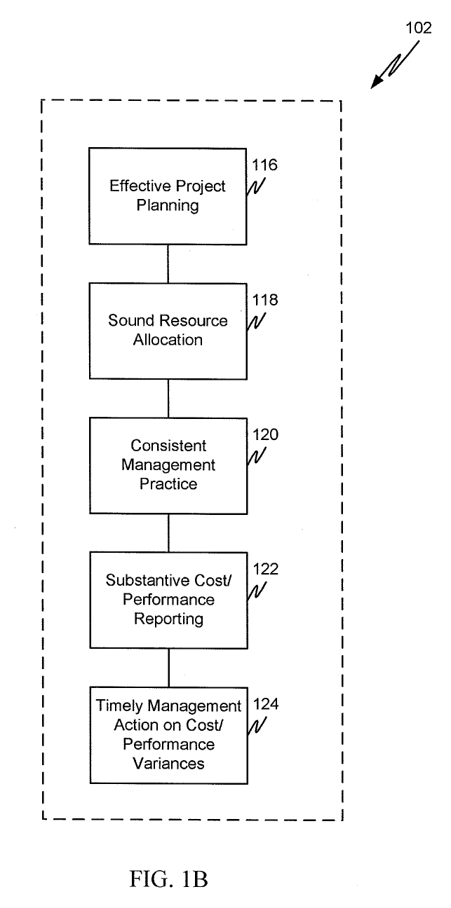

FIG. 1A is a block diagram of an exemplary embodiment of a system for continuous performance improvement in accordance with the present disclosure;

FIG. 1B is block diagram of an exemplary methodology implemented by the system of FIG. 1A in accordance with the present disclosure;

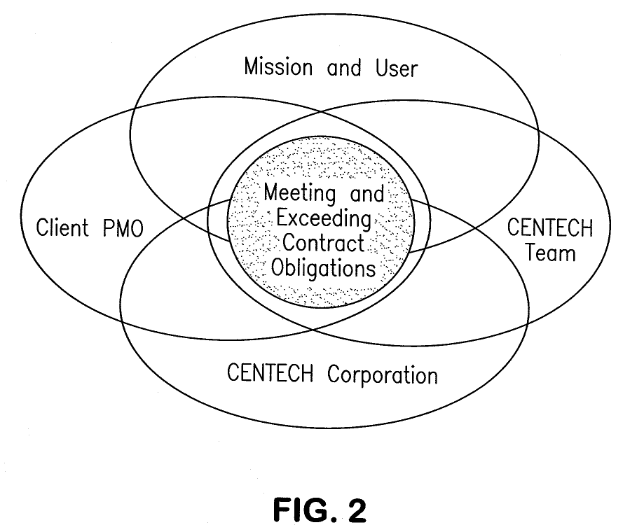

FIG. 2 is a diagrammatic illustration of exemplary stakeholders and their respective relationships to other stakeholders as connected by an exemplary system for continuous performance improvement;

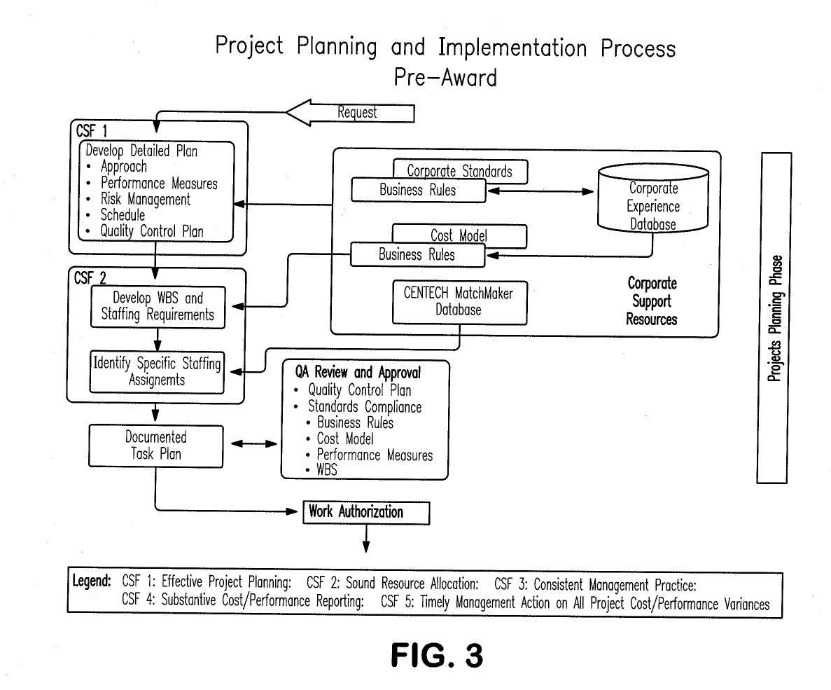

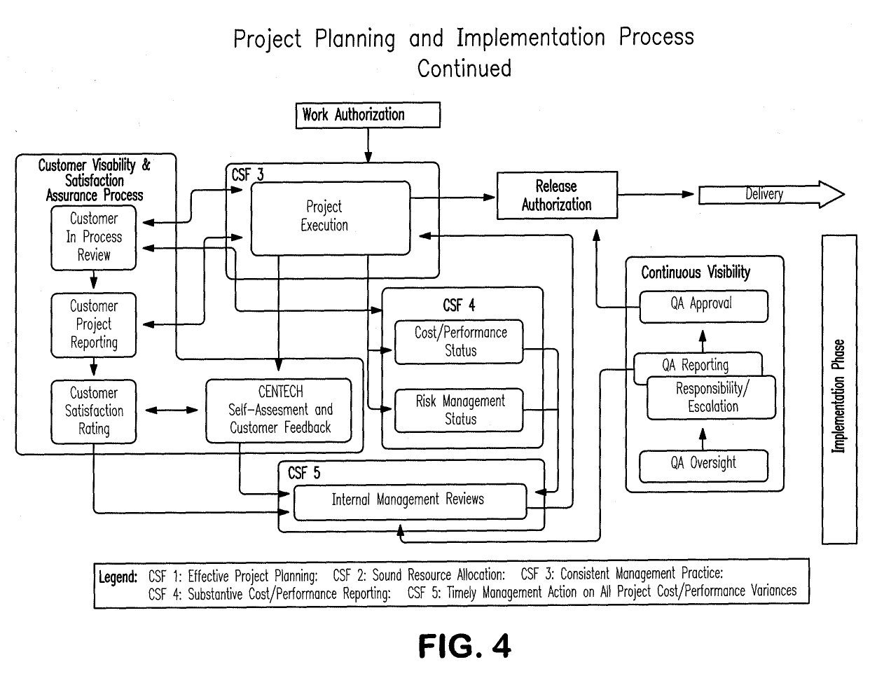

FIGS. 3 and 4 are a flowchart showing an exemplary method for continuous performance improvement in accordance with the present disclosure;

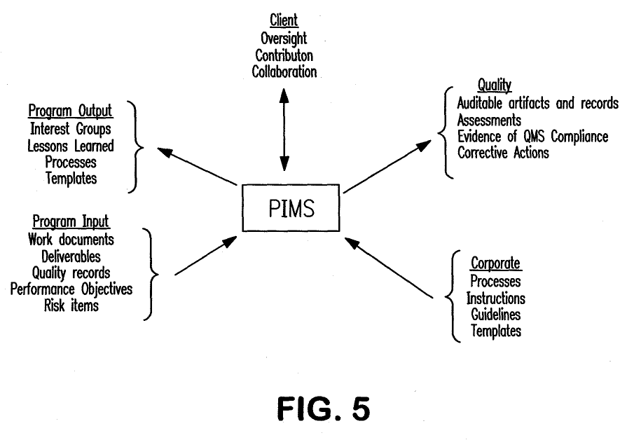

FIG. 5 is a block diagram of an exemplary web-based workspace in accordance with the present disclosure;

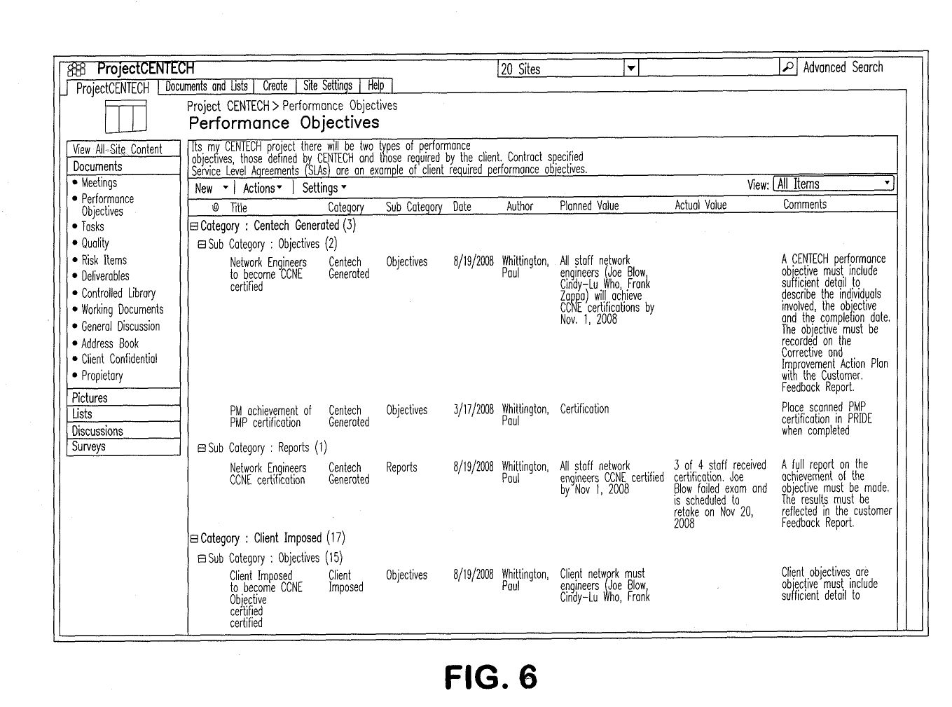

FIG. 6 is an exemplary user interface for the web-based workspace of FIG. 5 in accordance with the present disclosure;

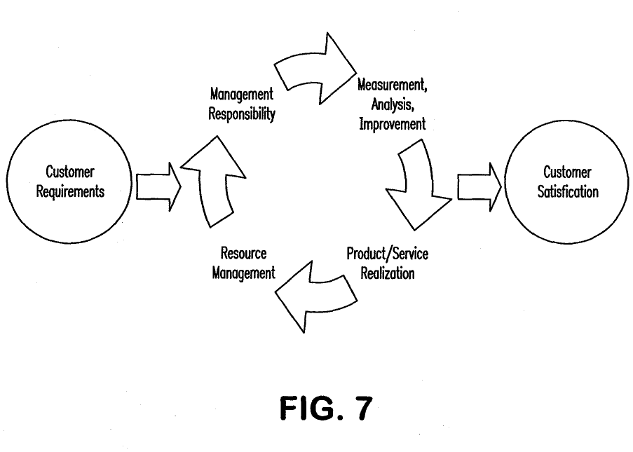

FIG. 7 is diagrammatic illustration of an exemplary process for receiving customer requirements as input and monitoring customer satisfaction in accordance with the present disclosure;

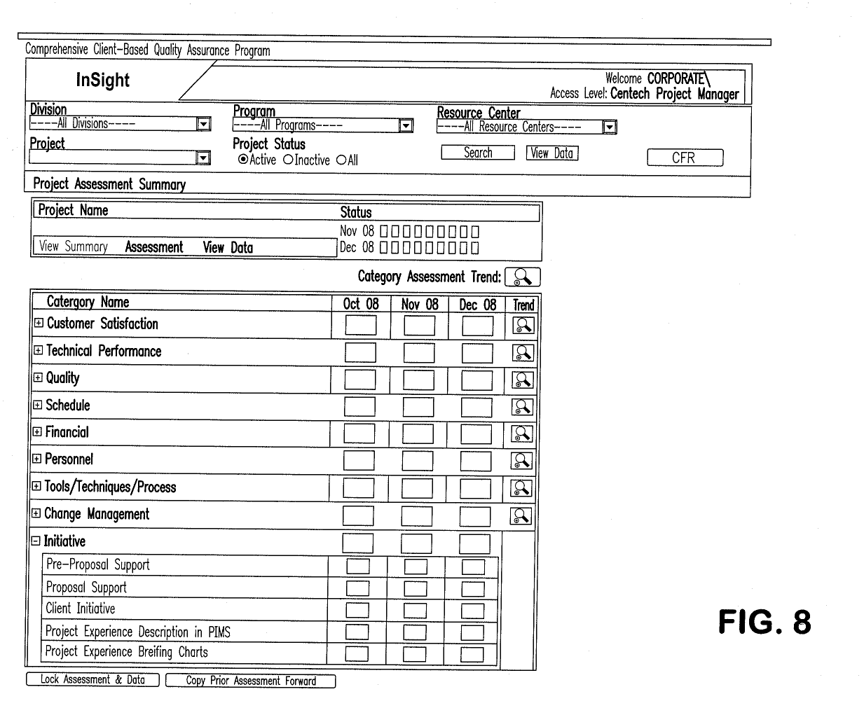

FIG. 8 is an exemplary user interface for project management assessment tool in accordance with the present disclosure;

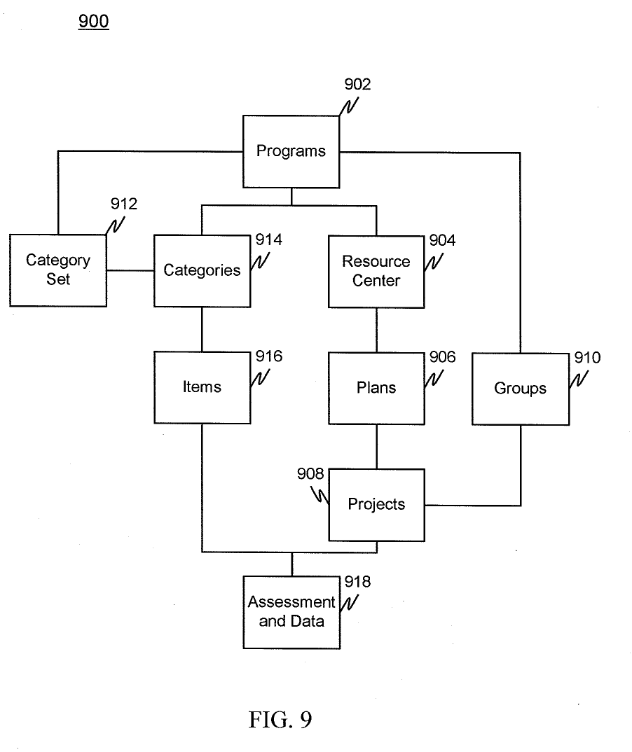

FIG. 9 is a block diagram of an exemplary project performance manager system in accordance with the present disclosure;

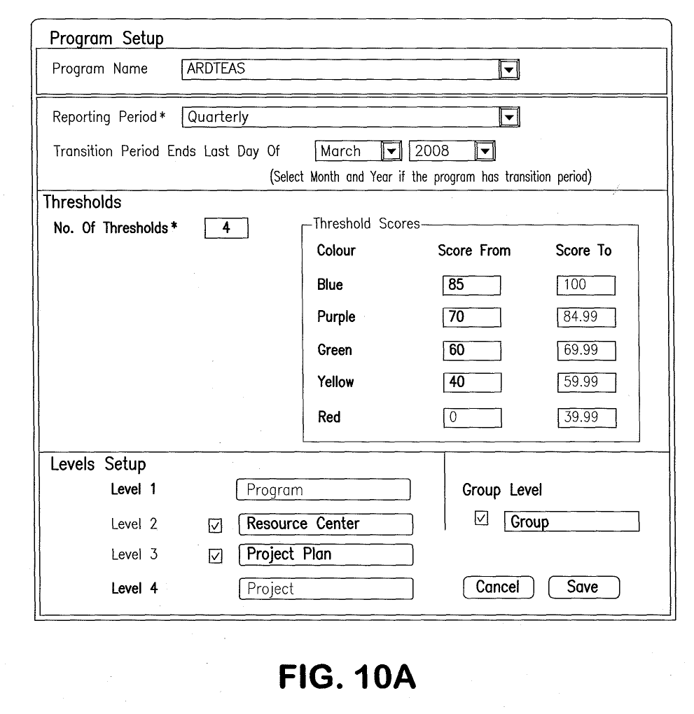

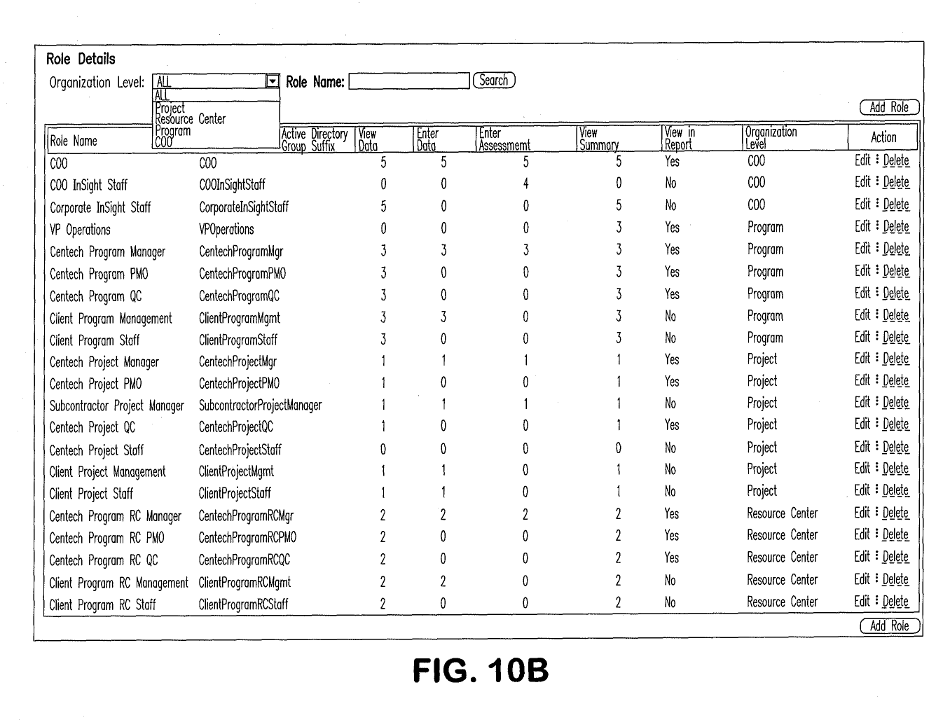

FIGS. 10-14 show exemplary project performance manager system user interface screens in accordance with the present disclosure;

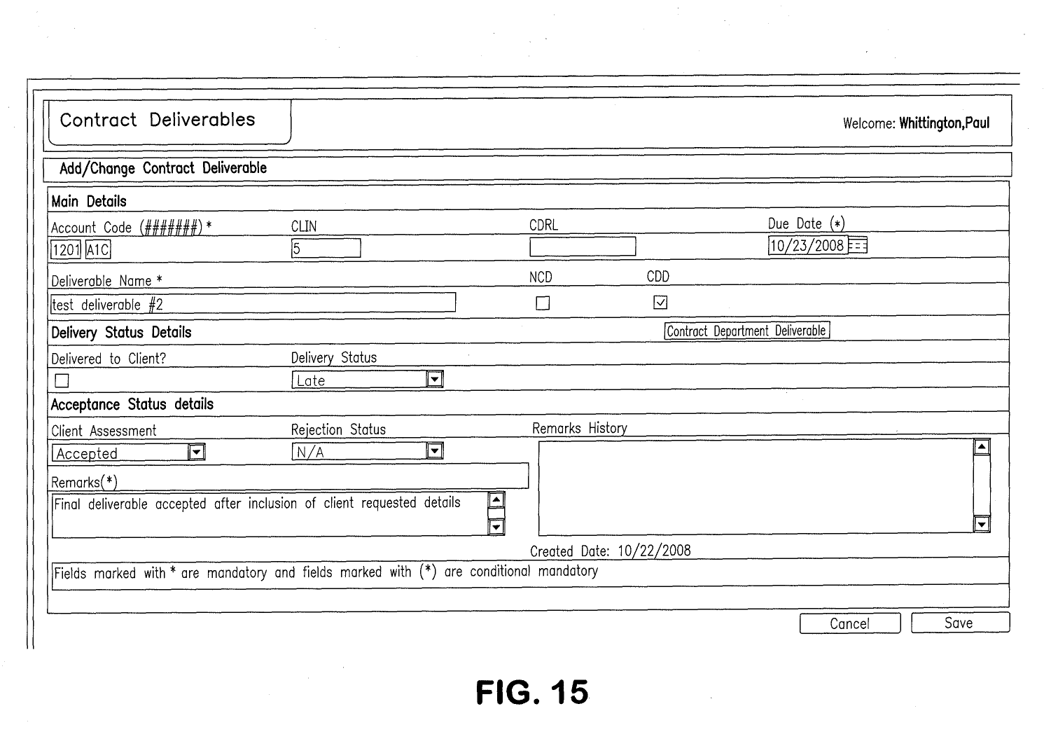

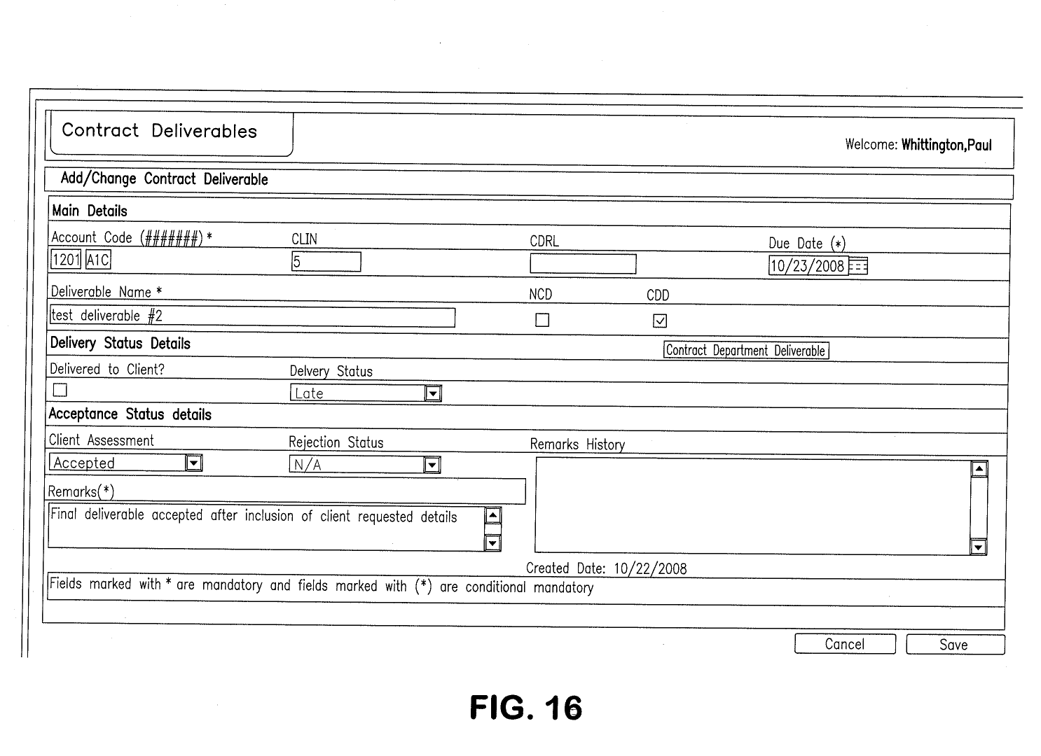

FIGS. 15-16 show exemplary contract deliverables user interface screens in accordance with the present disclosure;

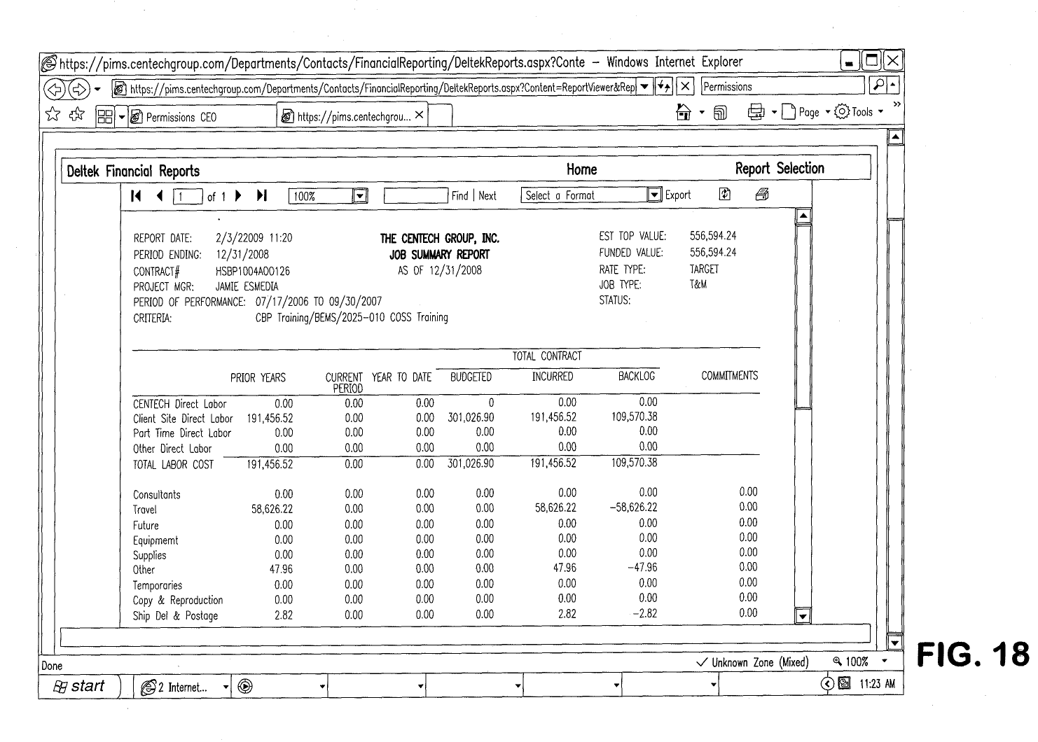

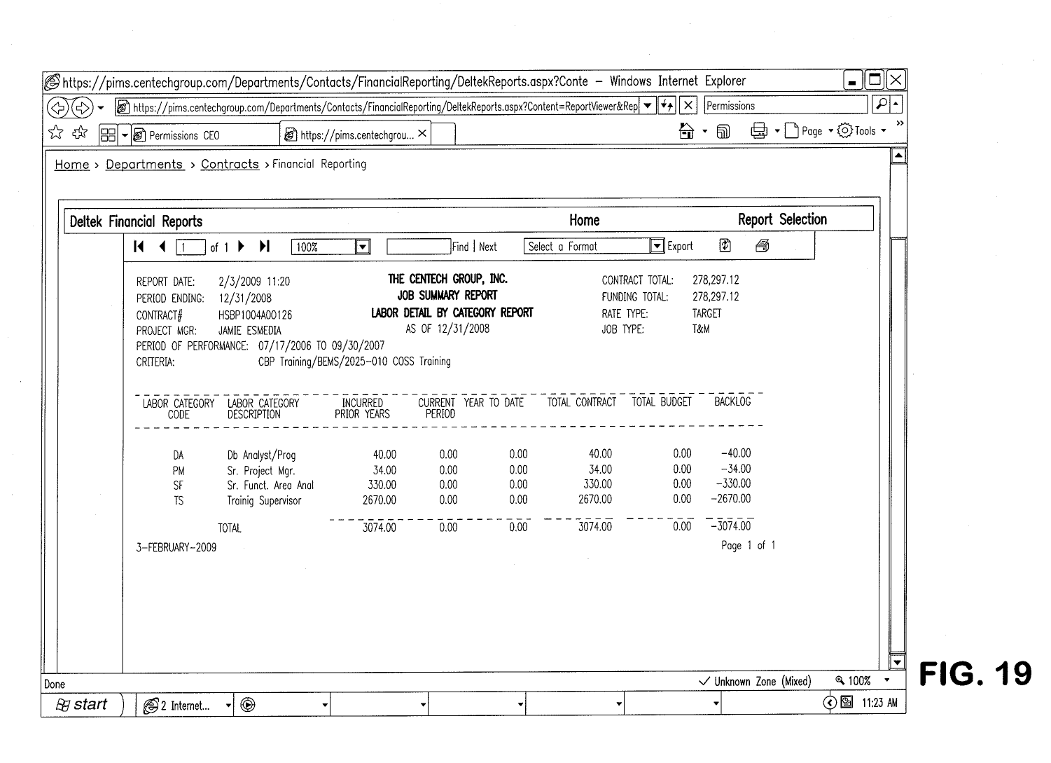

FIGS. 18-19 show exemplary financial reporting user interface screens in accordance with the present disclosure;

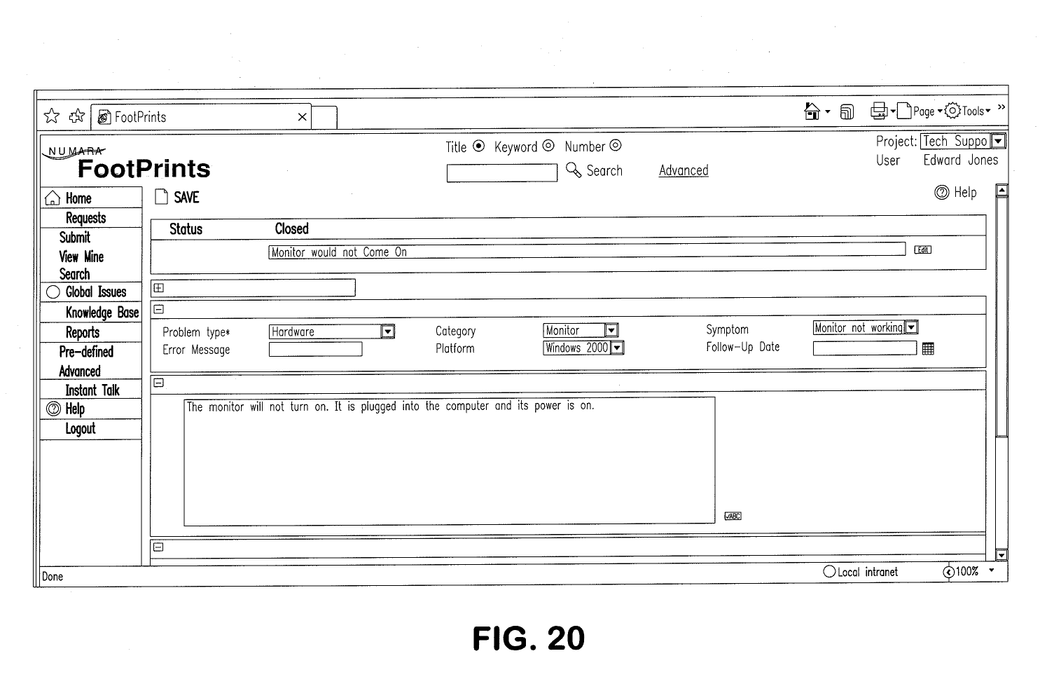

FIG. 20 shows an exemplary web-based trouble ticket user interface screen in accordance with the present disclosure;

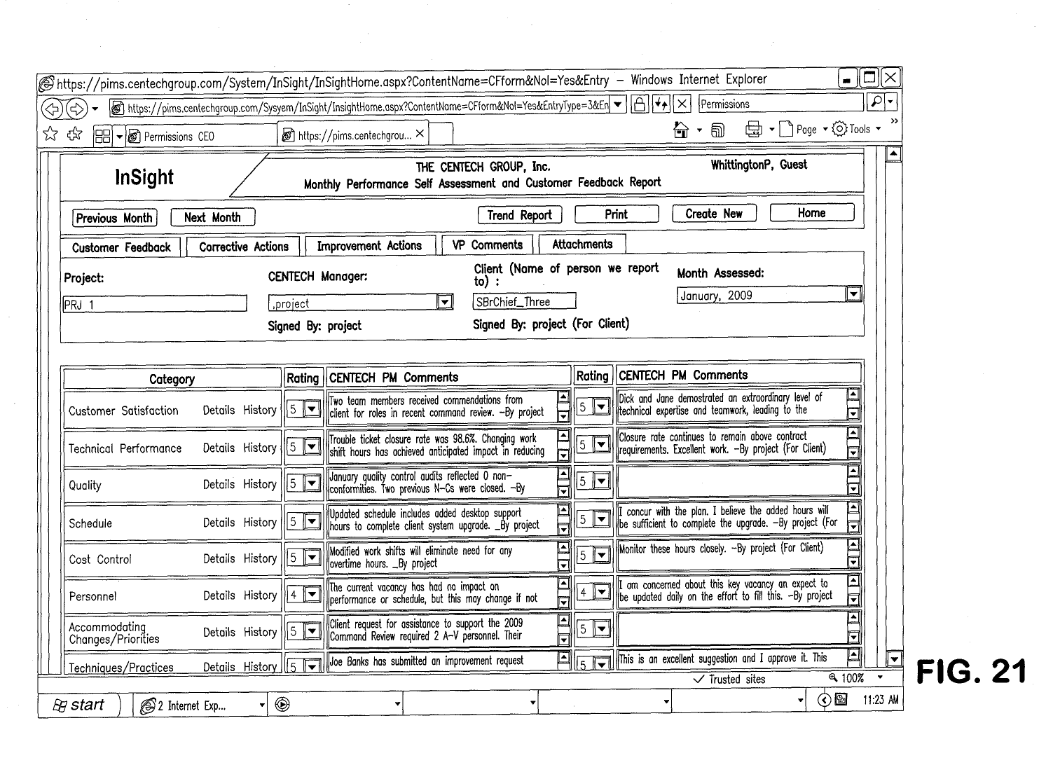

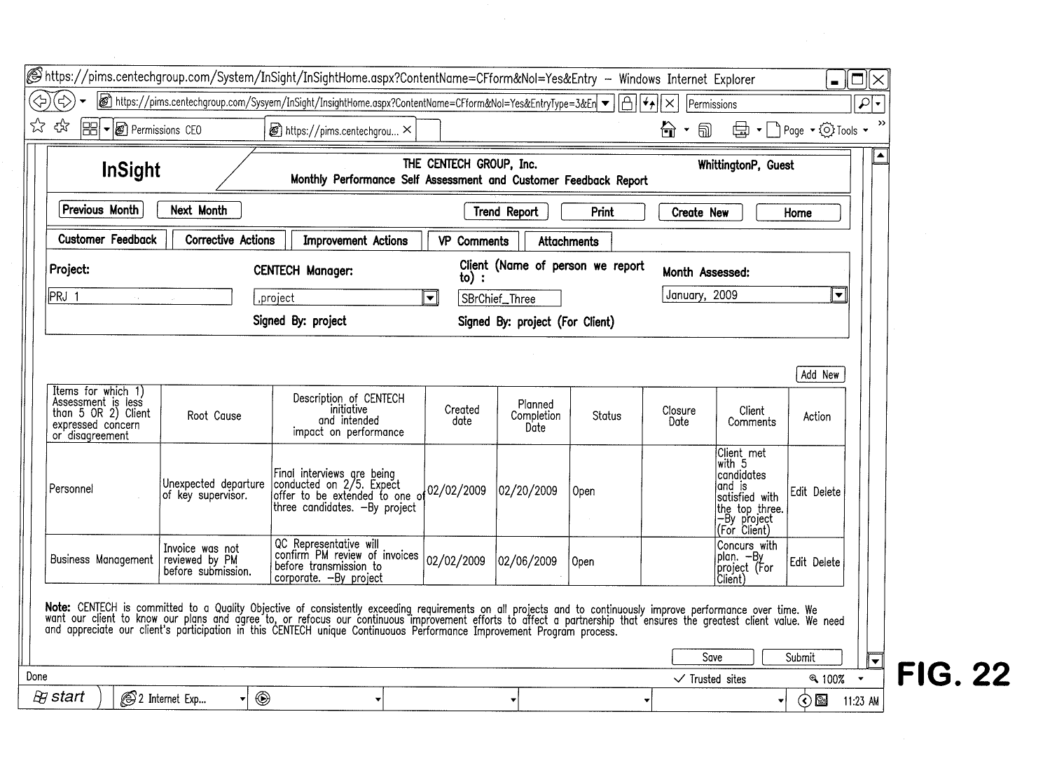

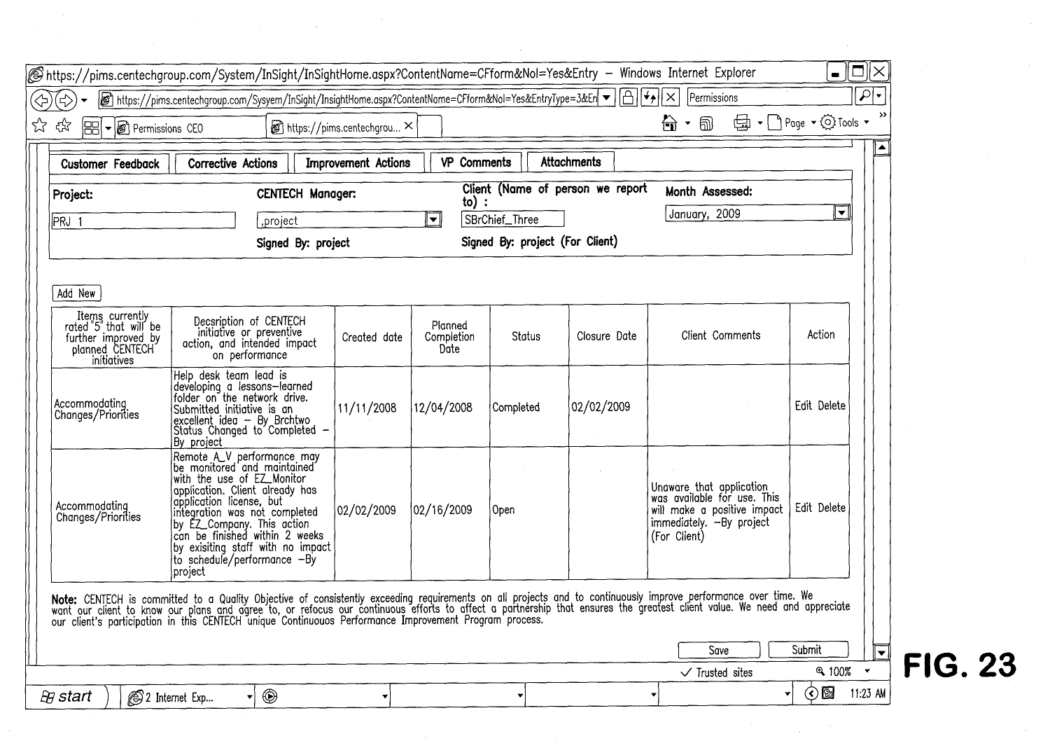

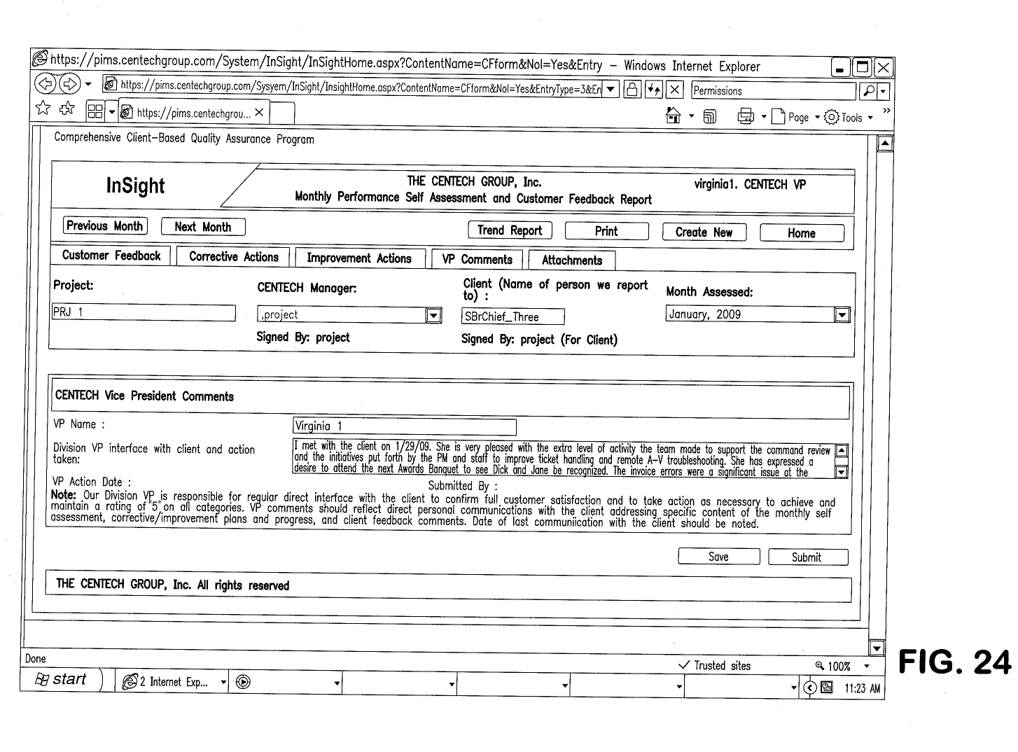

FIGS. 21-24 show exemplary customer satisfaction assurance process user interface screens in accordance with the present disclosure;

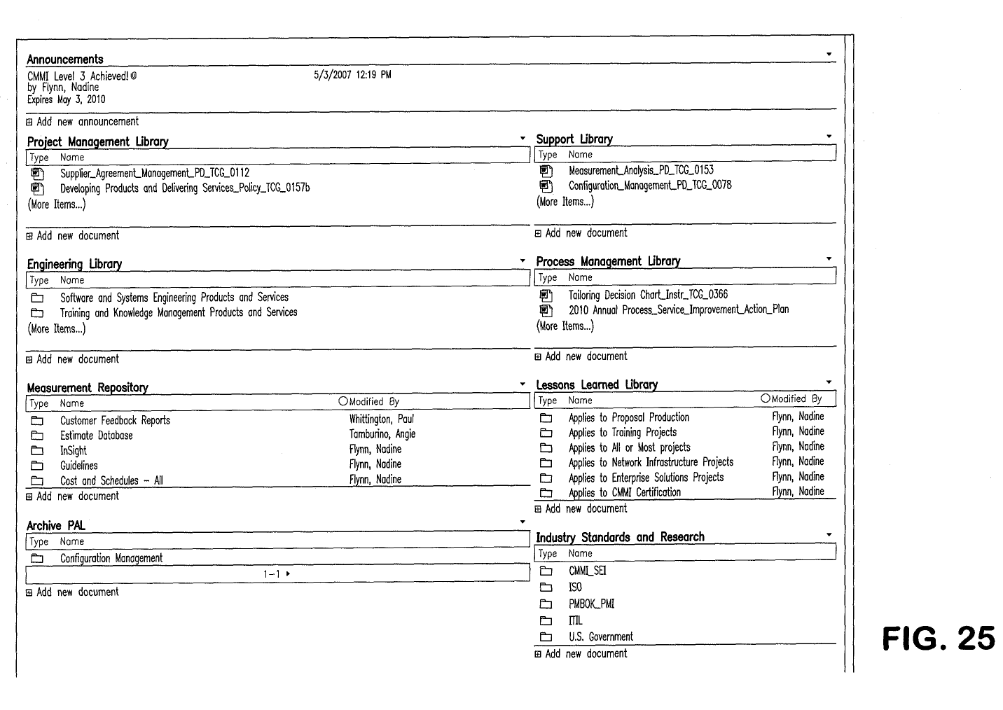

FIG. 25 shows an exemplary user interface screen for accessing libraries and repositories of process descriptions, procedures, templates and forms in accordance with the present disclosure;

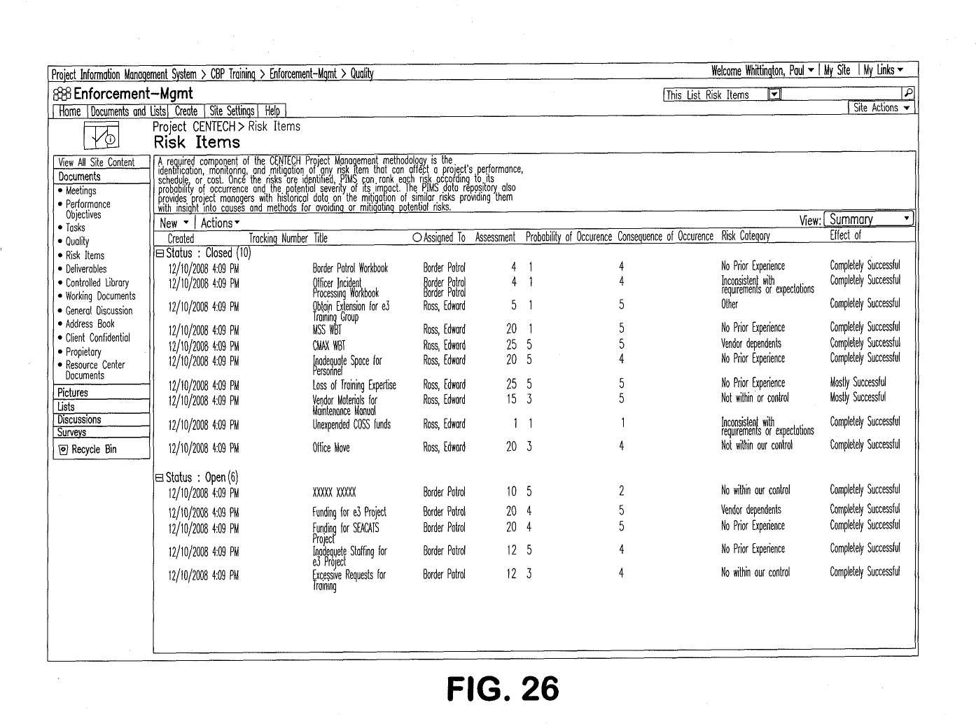

FIG. 26 shows an exemplary risk management user interface in accordance with the present disclosure;

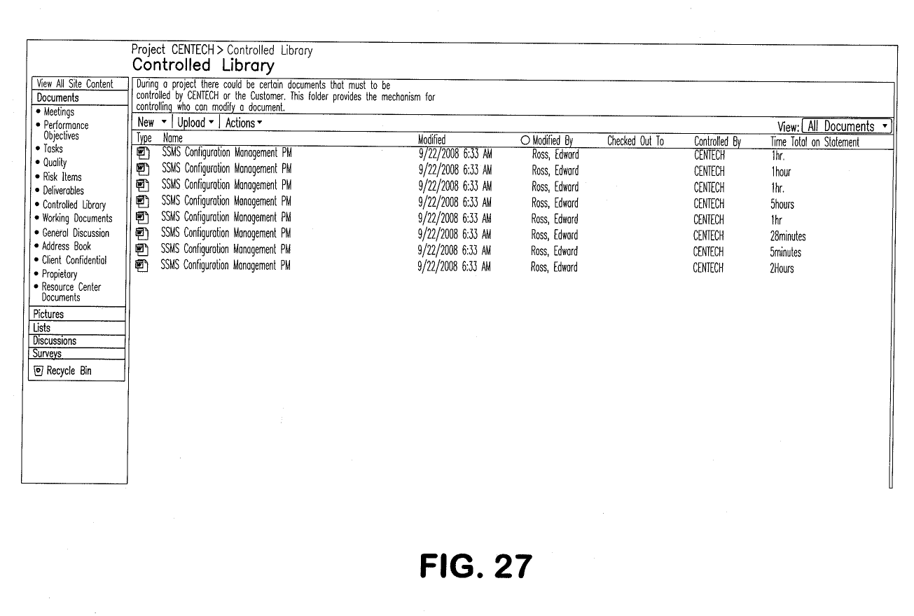

FIG. 27 shows an exemplary controlled library user interface in accordance with the present disclosure;

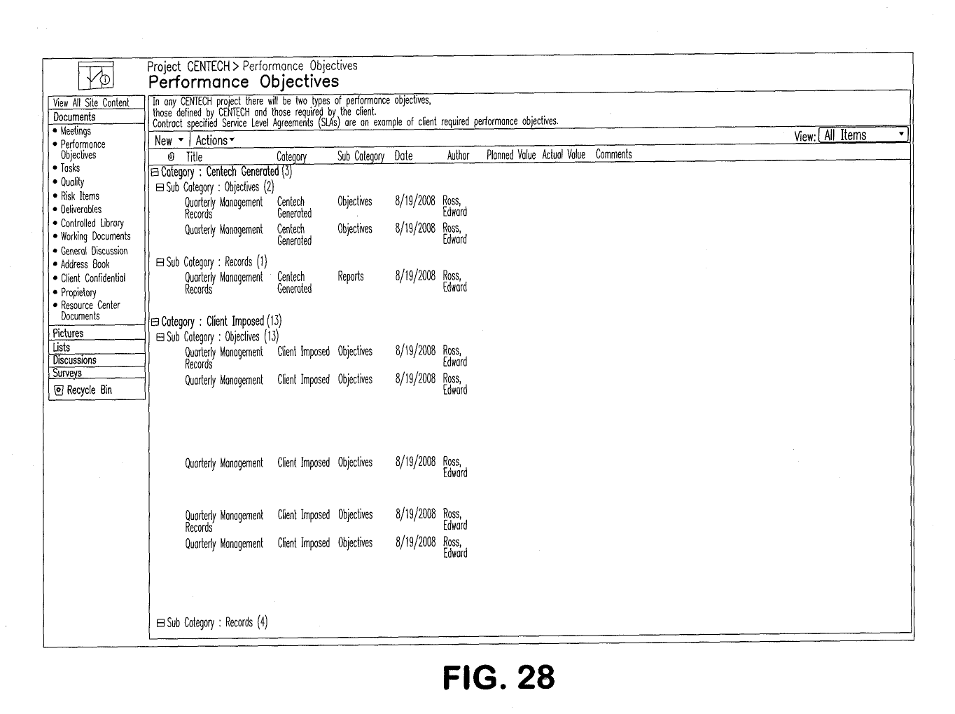

FIG. 28 shows an exemplary performance objective user interface in accordance with the present disclosure;

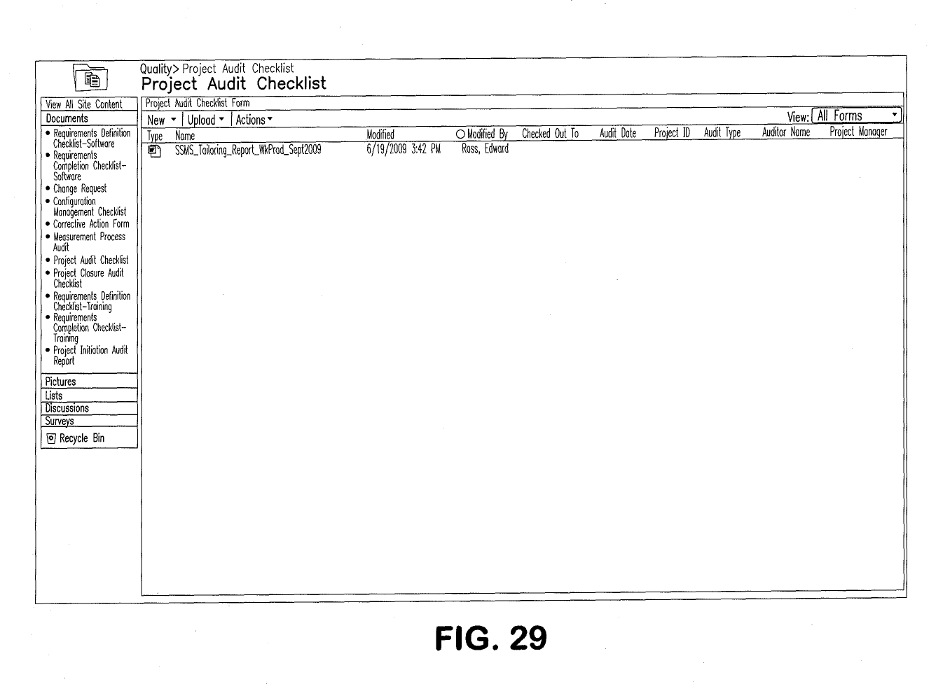

FIG. 29 shows an exemplary project audit checklist user interface in accordance with the present disclosure;

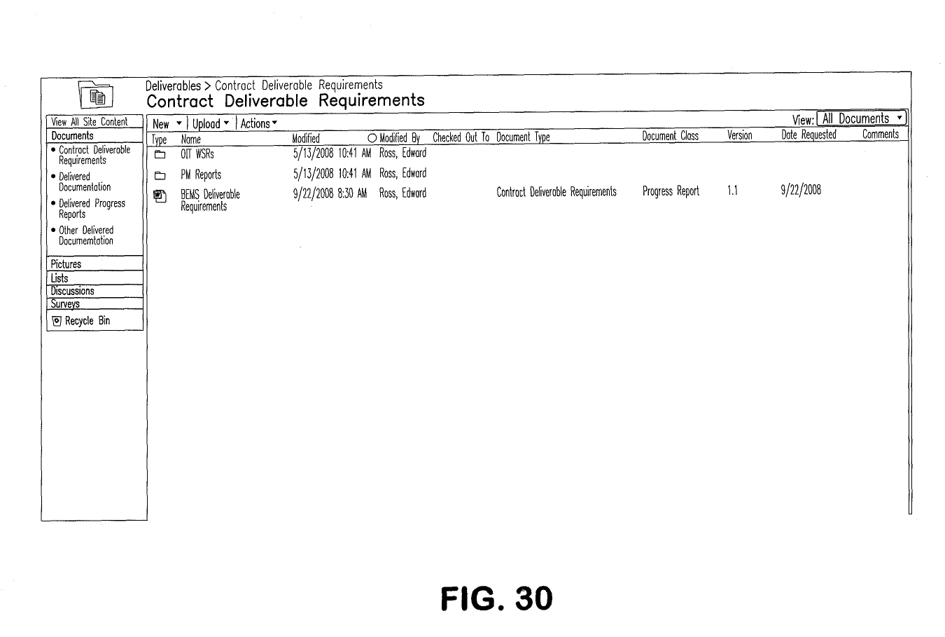

FIG. 30 shows an exemplary contract deliverables requirements user interface in accordance with the present disclosure;

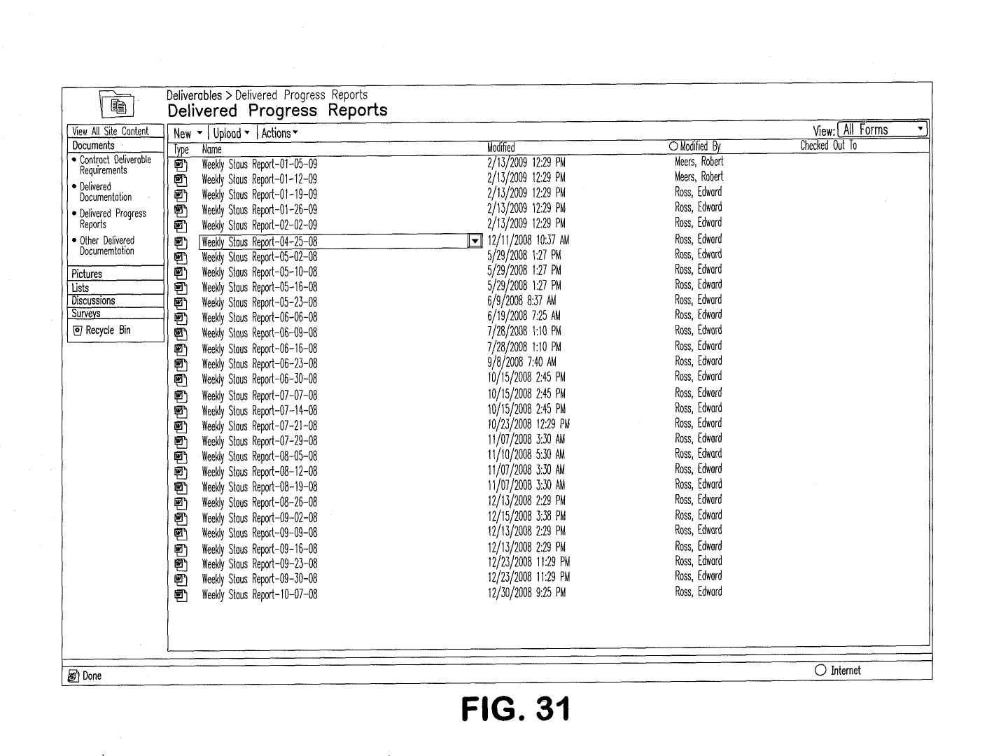

FIG. 31 shows an exemplary delivered progress report user interface in accordance with the present disclosure;

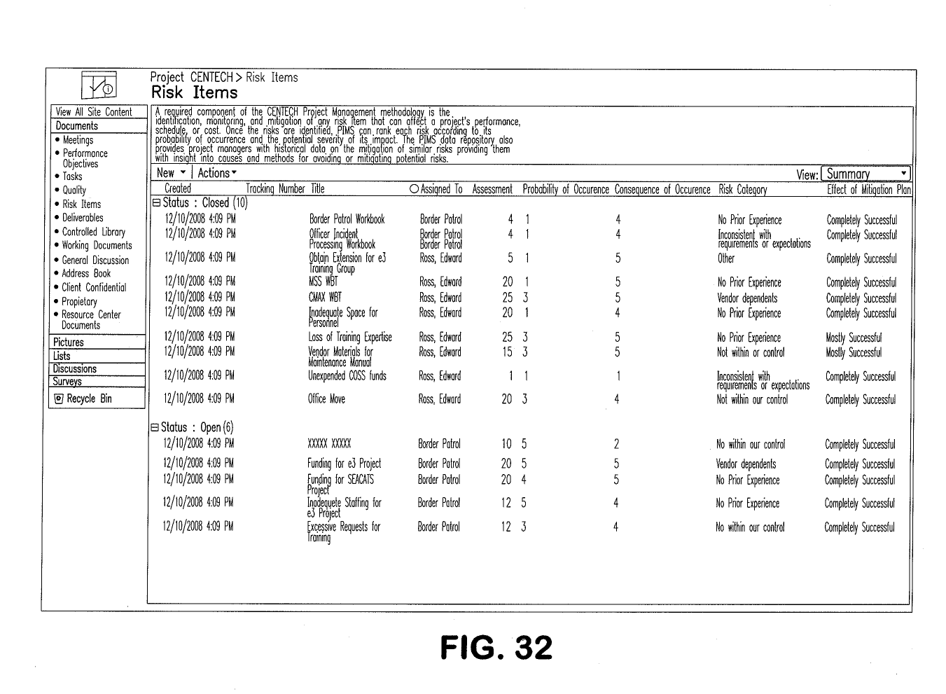

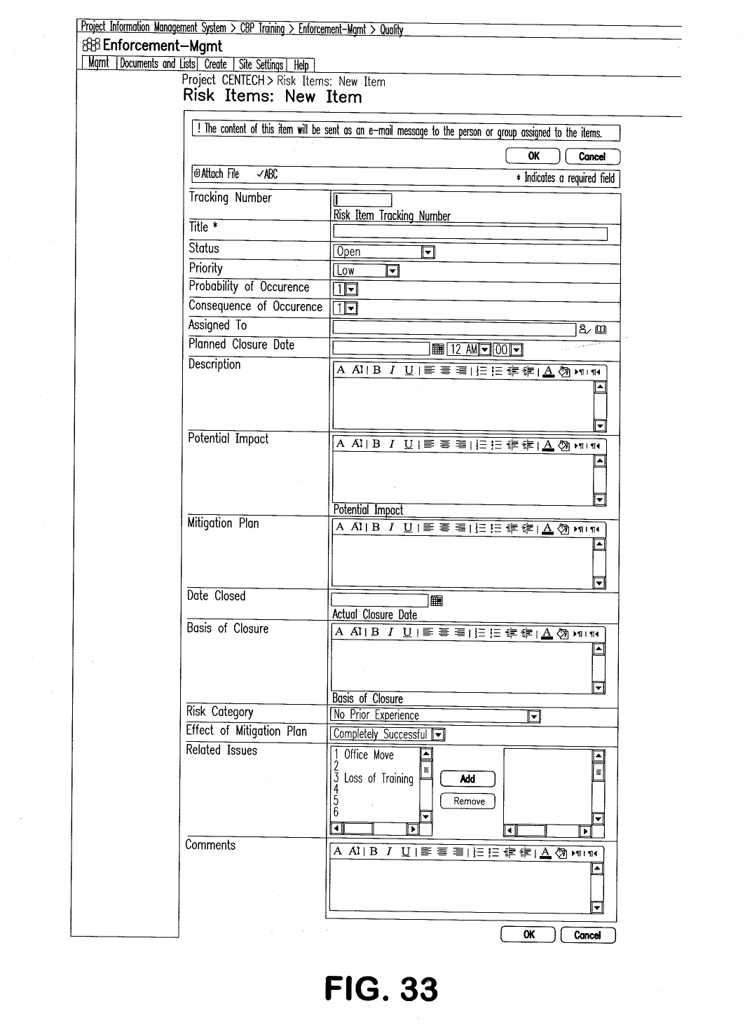

FIGS. 32-33 show an exemplary risk items user interface in accordance with the present disclosure;

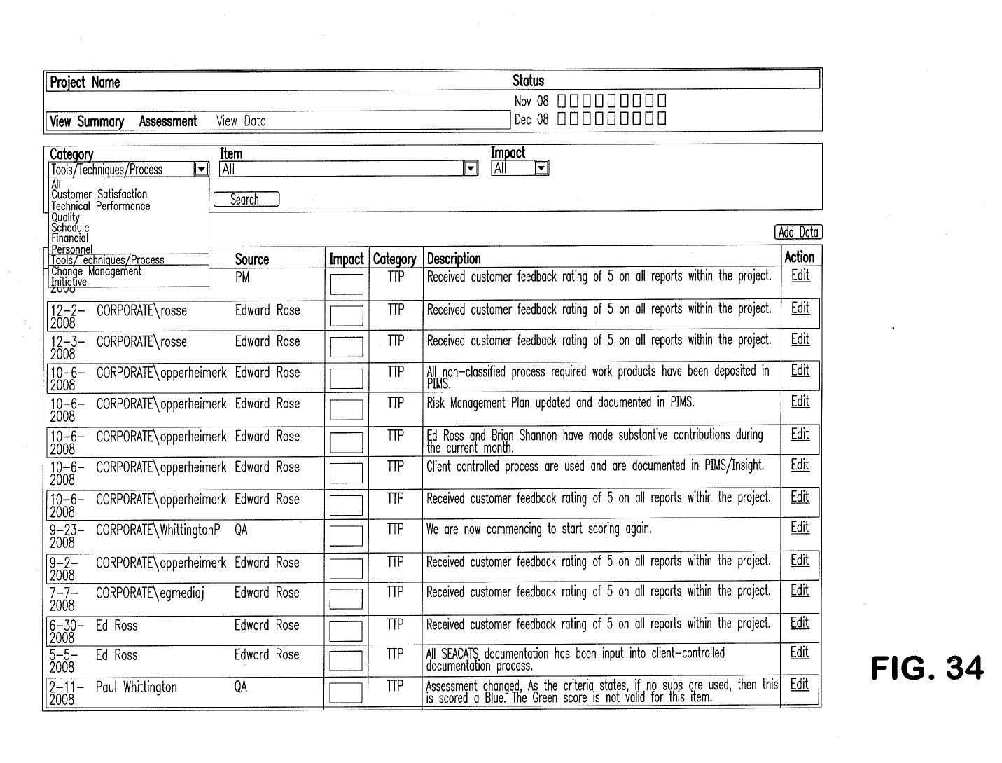

FIG. 34 shows an exemplary management visibility user interface in accordance with the present disclosure;

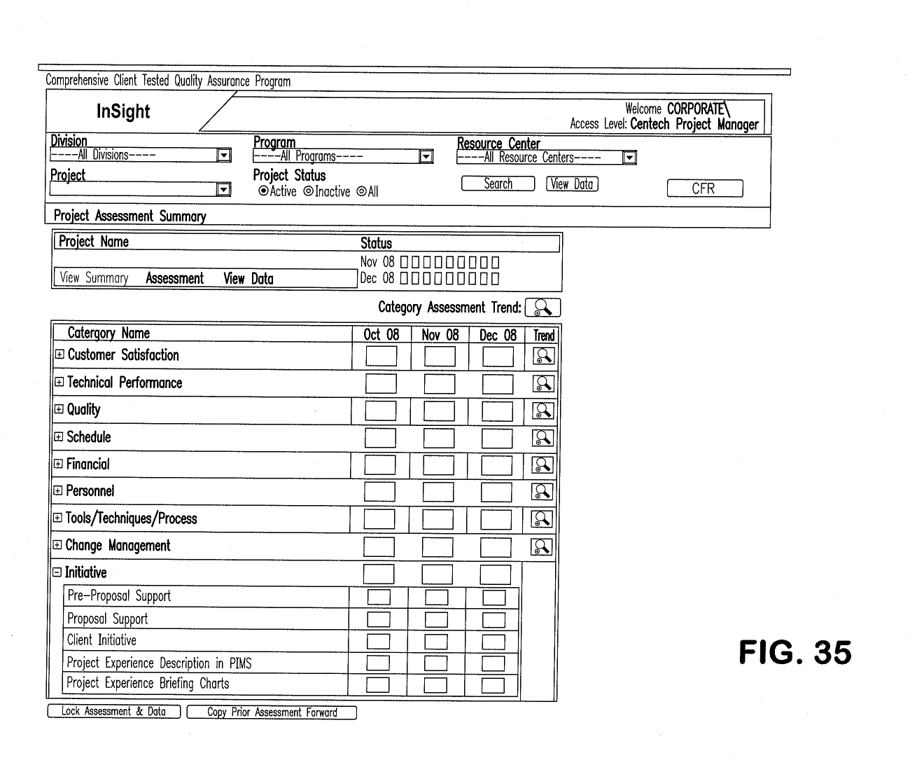

FIG. 35 shows an exemplary management view of assessment scores user interface in accordance with the present disclosure;

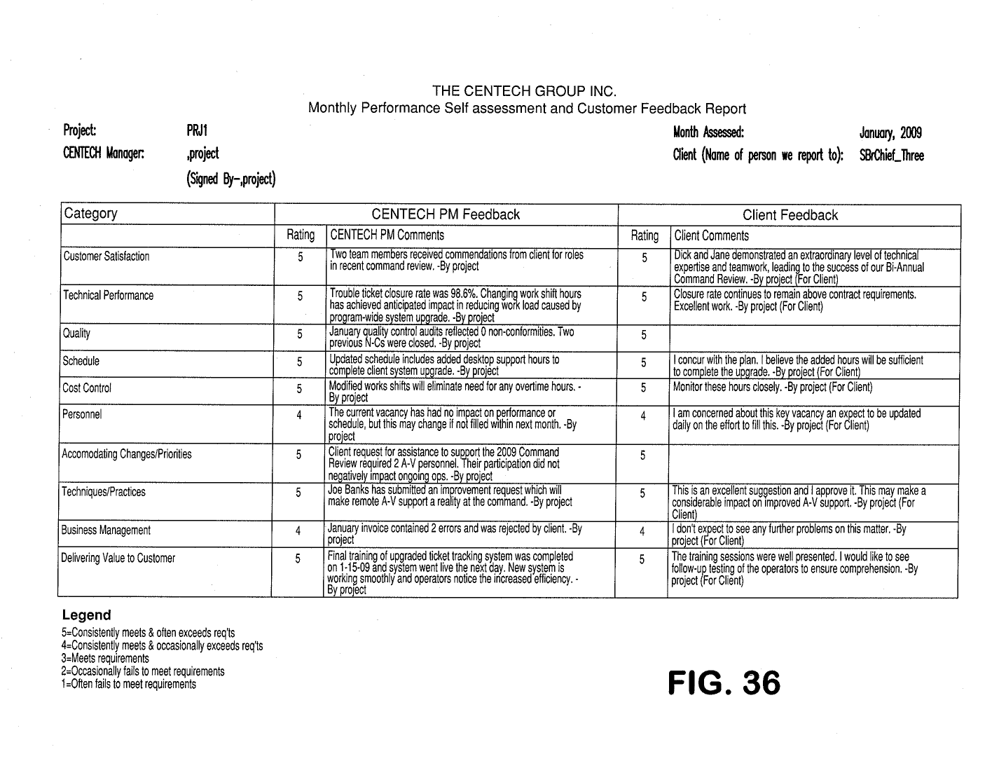

FIG. 36 shows an exemplary self assessment and client feedback report in accordance with the present disclosure;

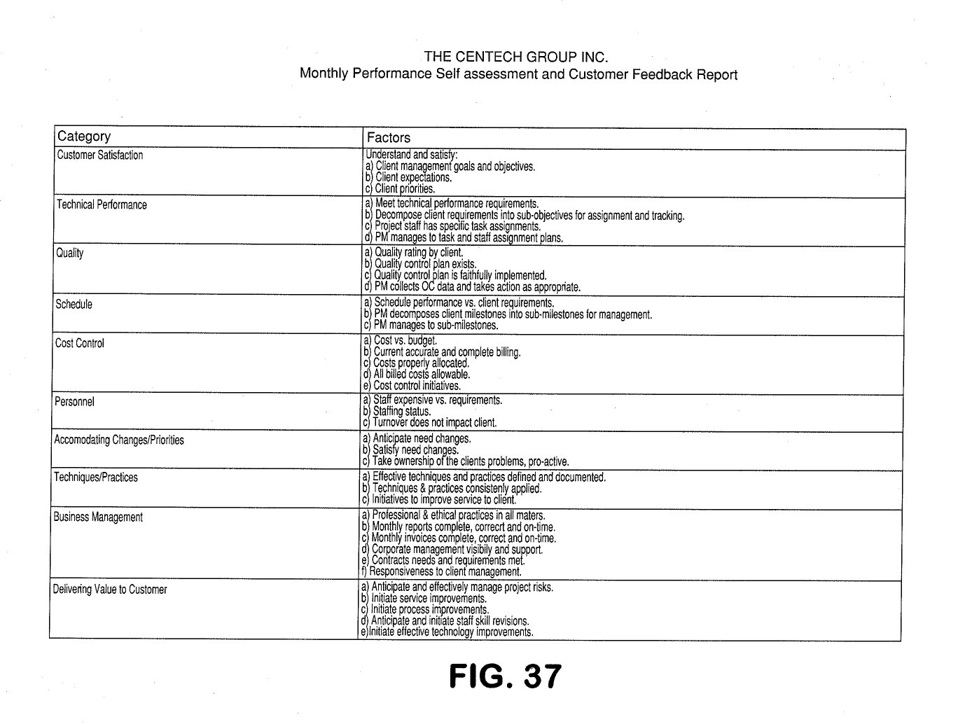

FIG. 37 shows exemplary detailed evaluation criteria in accordance with the present disclosure;

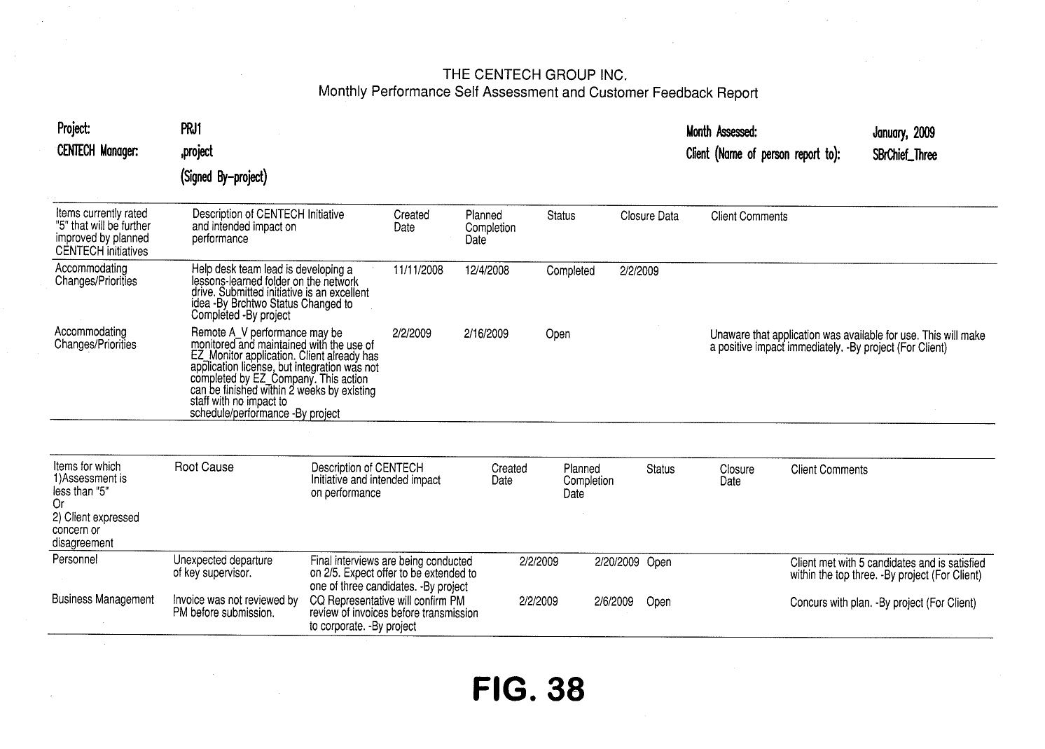

FIG. 38 shows an exemplary root cause analysis report in accordance with the present disclosure;

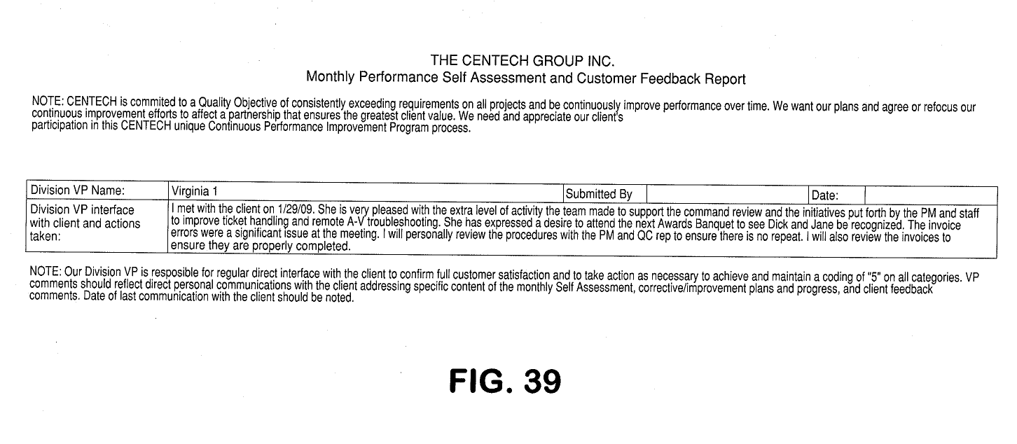

FIG. 39 shows an exemplary management self assessment and customer feedback report in accordance with the present disclosure;

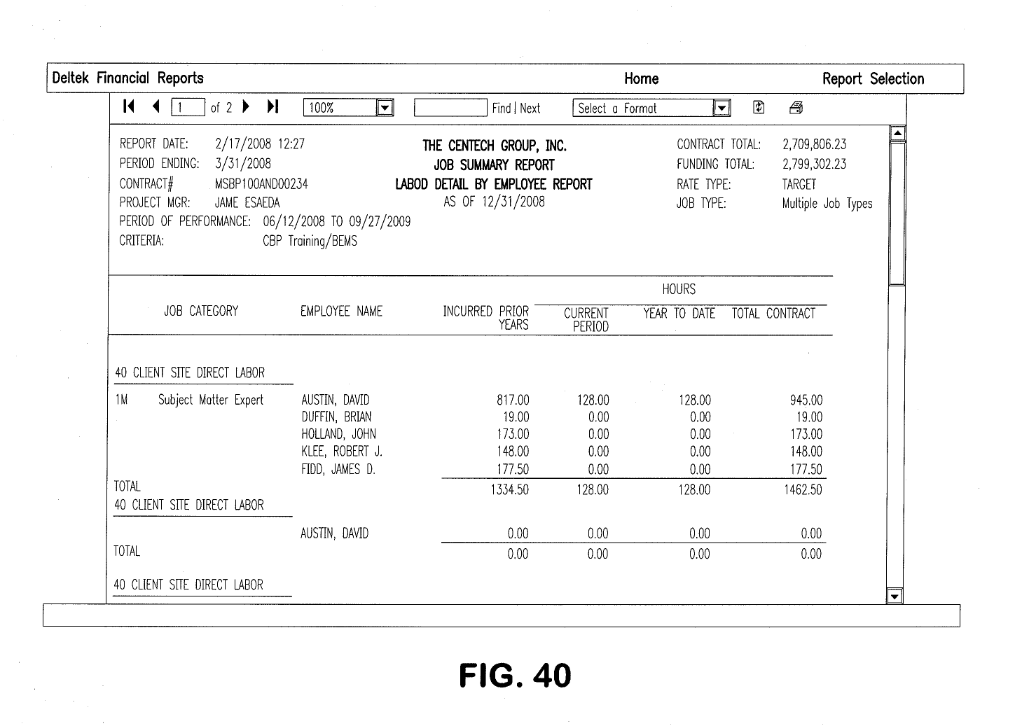

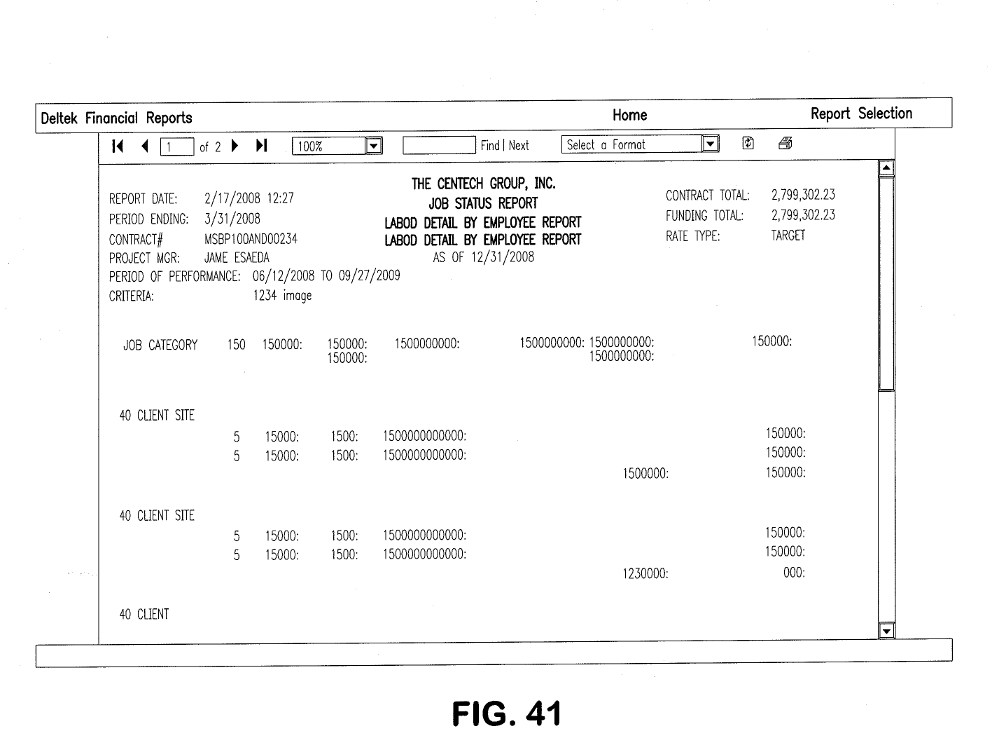

FIGS. 40-41 show an exemplary comprehensive risk management user interface in accordance with the present disclosure;

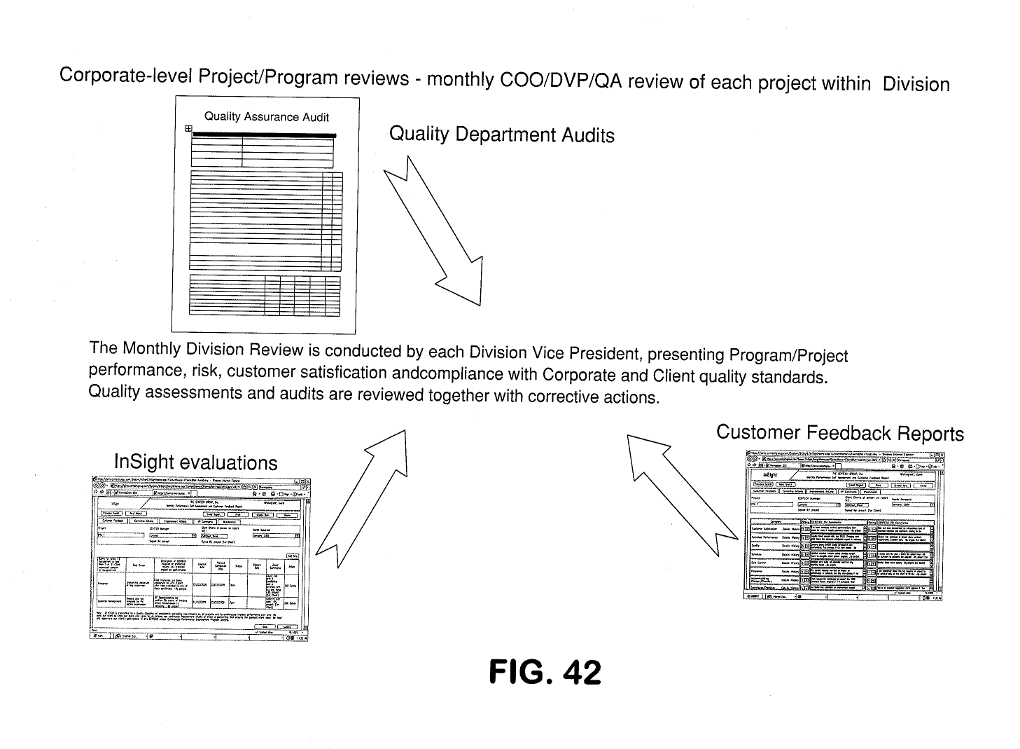

FIG. 42 is a block diagram of a comprehensive risk management method in accordance with the present disclosure;

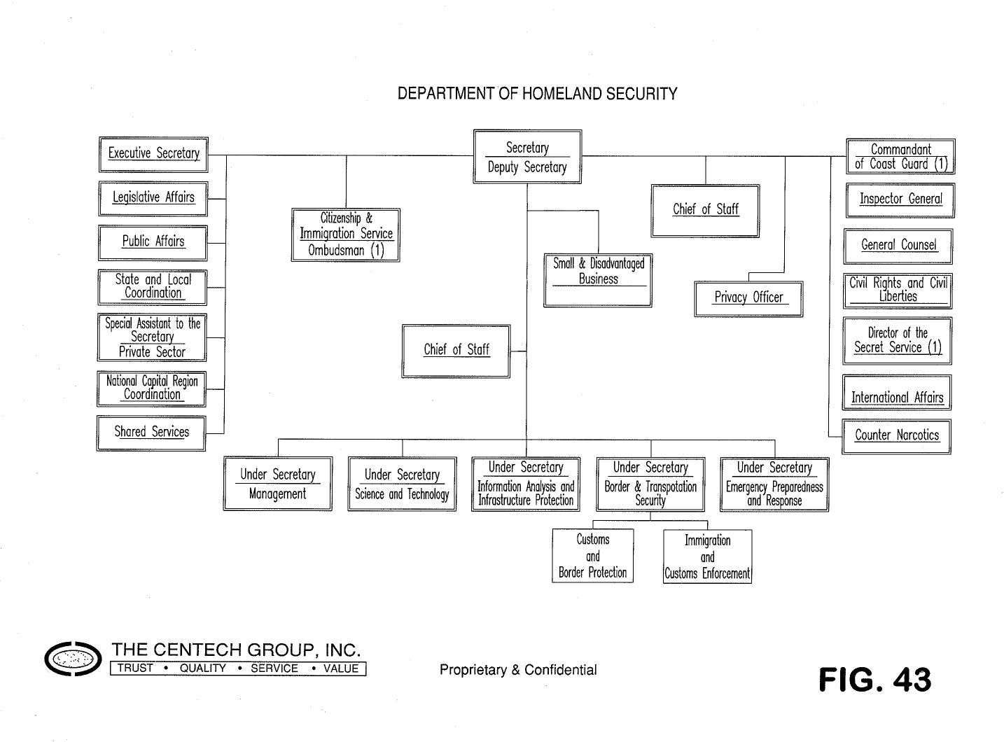

FIG. 43 is a diagram of a comprehensive risk management stakeholder chart in accordance with the present disclosure;

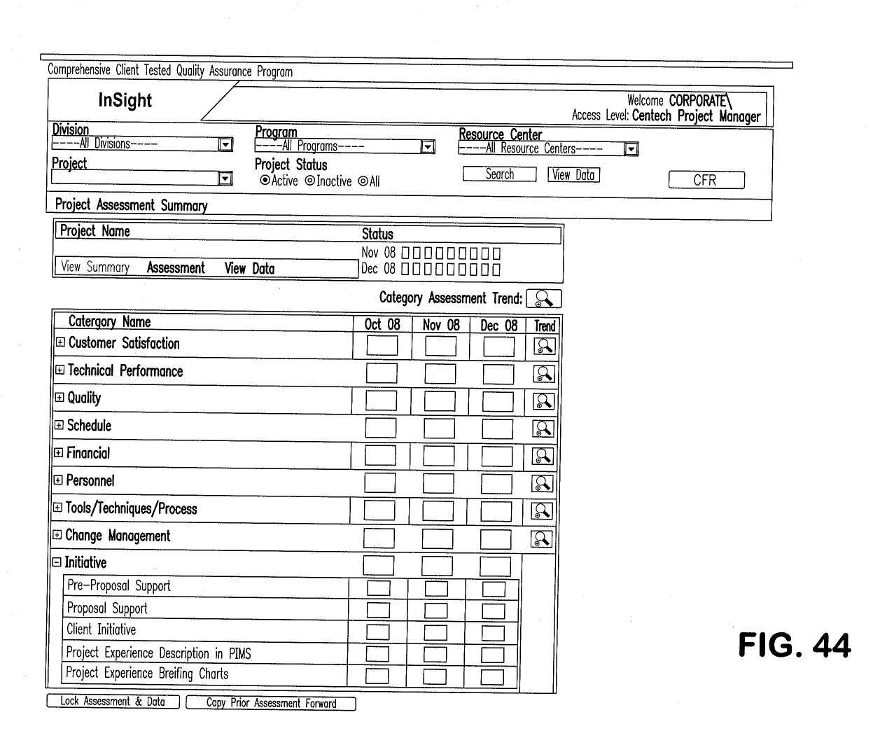

FIG. 44 is a diagram of a comprehensive risk management customer feedback report in accordance with the present disclosure;

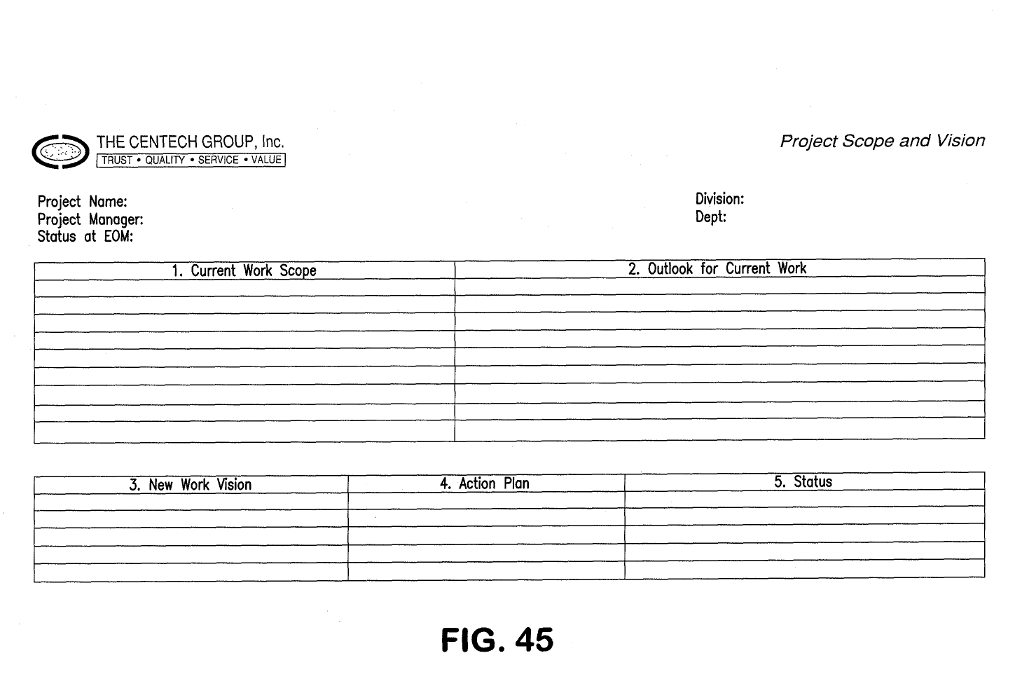

FIG. 45 is an exemplary comprehensive risk management project compliance user interface in accordance with the present disclosure;

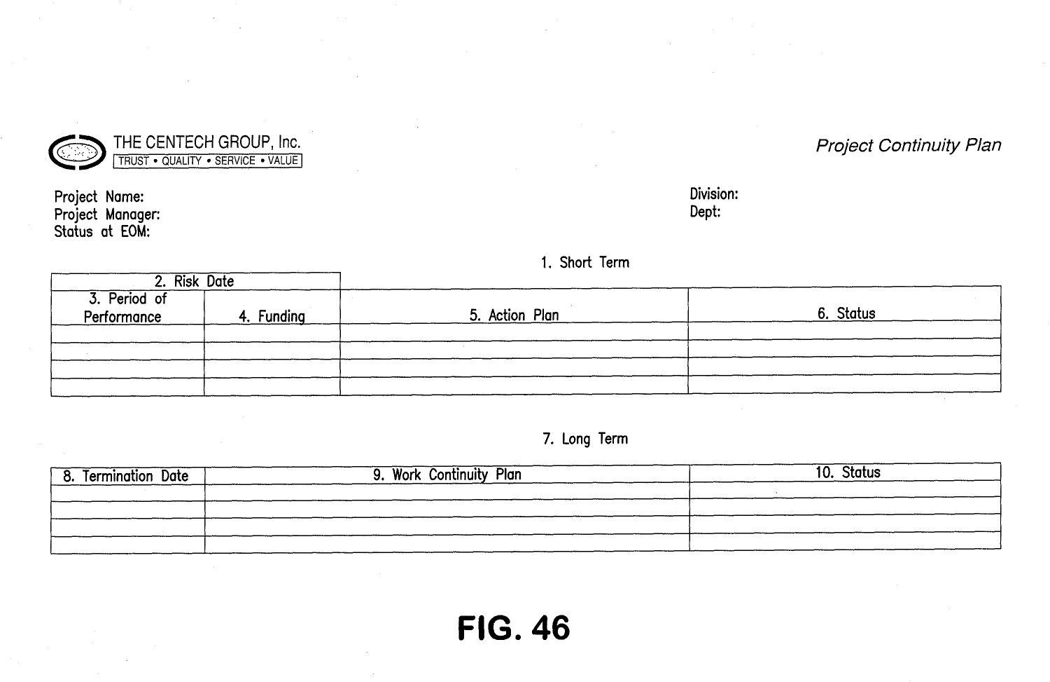

FIG. 46 is an exemplary comprehensive risk management project scope and vision user interface in accordance with the present disclosure;

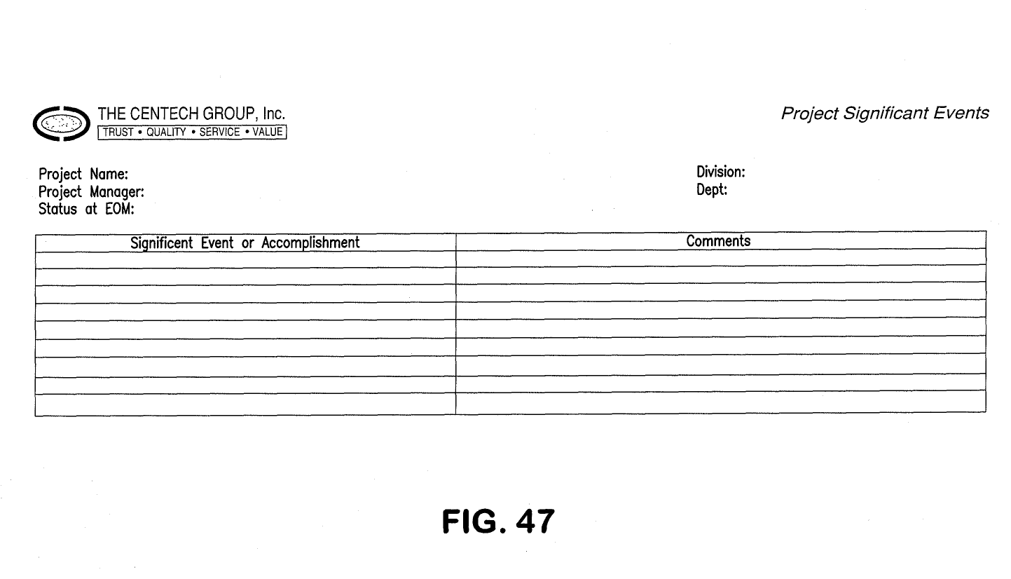

FIG. 47 is an exemplary comprehensive risk management project significant events user interface in accordance with the present disclosure;

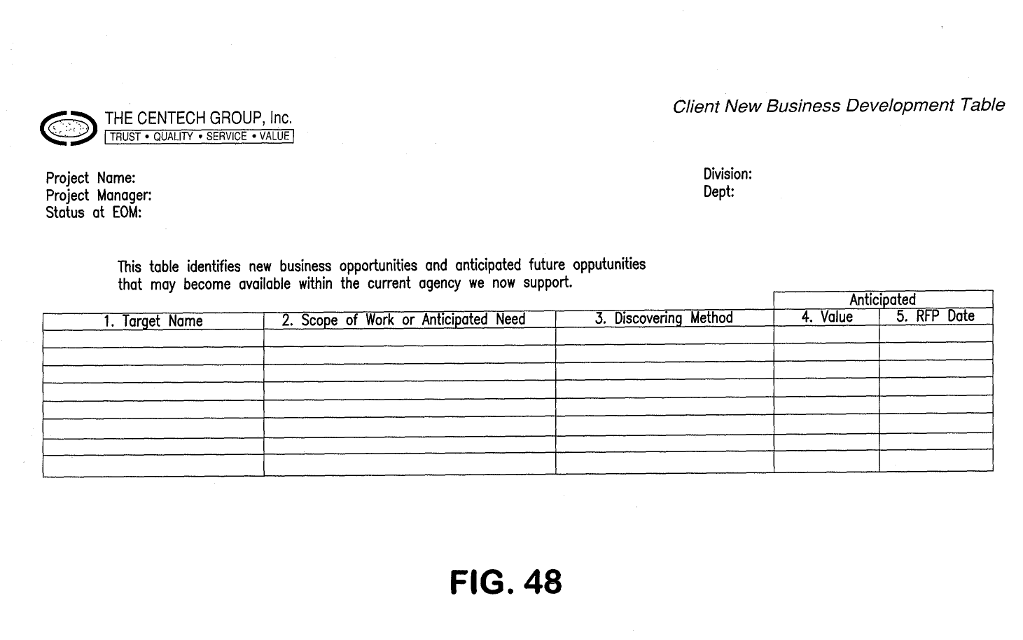

FIG. 48 is an exemplary comprehensive risk management client new business development user interface in accordance with the present disclosure;

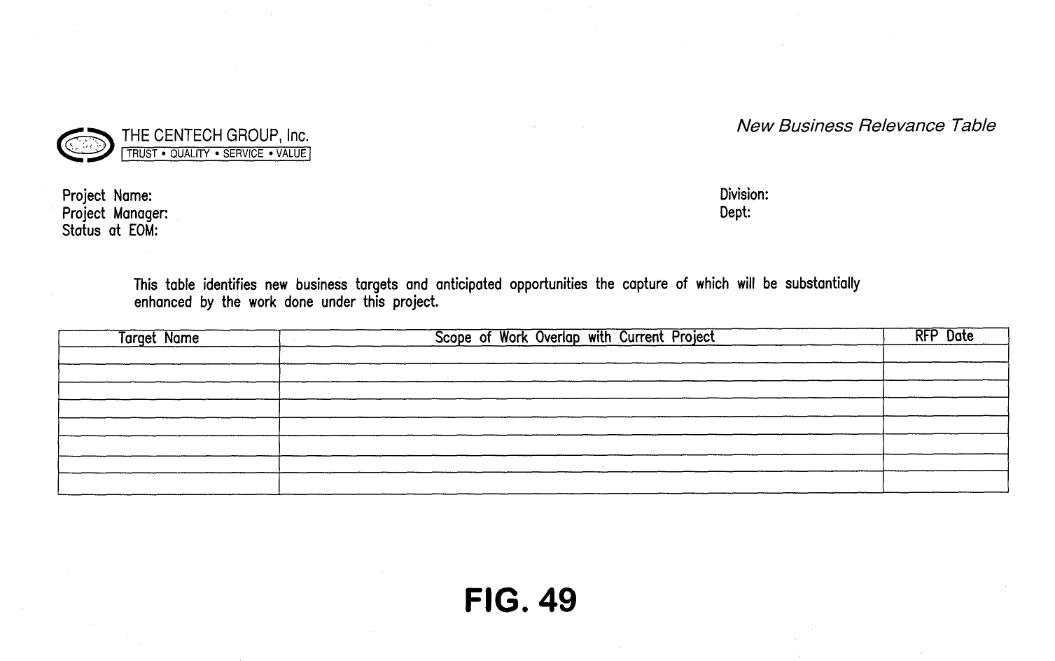

FIG. 49 is an exemplary comprehensive risk management new business relevance user interface in accordance with the present disclosure;

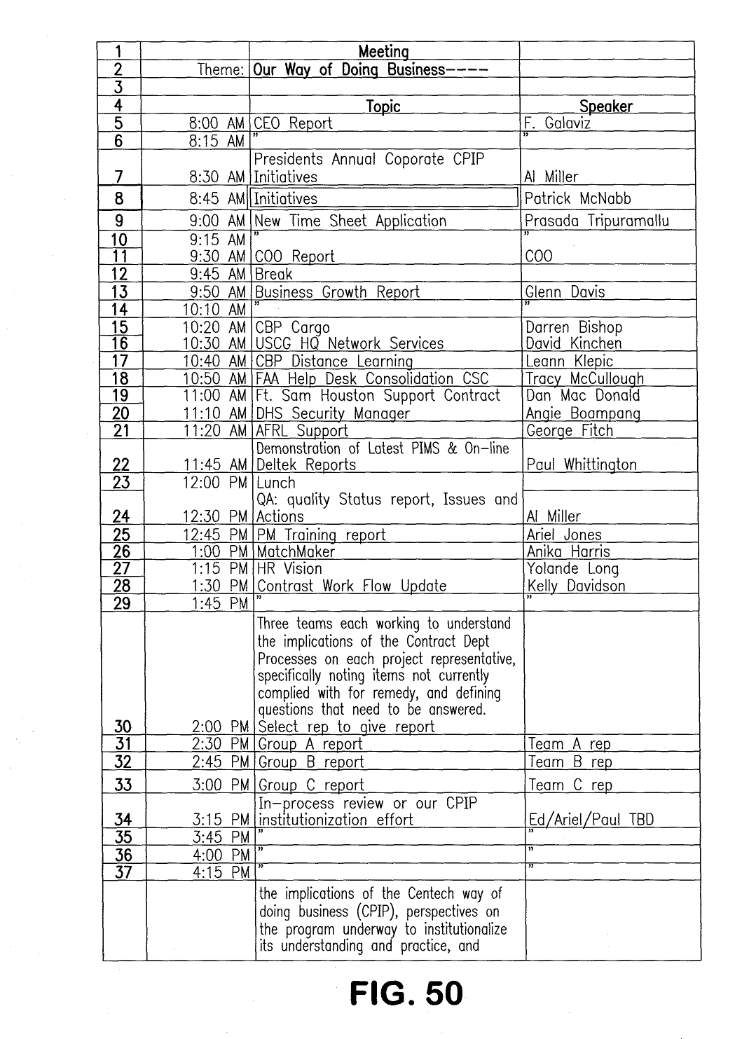

FIG. 50 is an exemplary comprehensive risk management meeting agenda in accordance with the present disclosure;

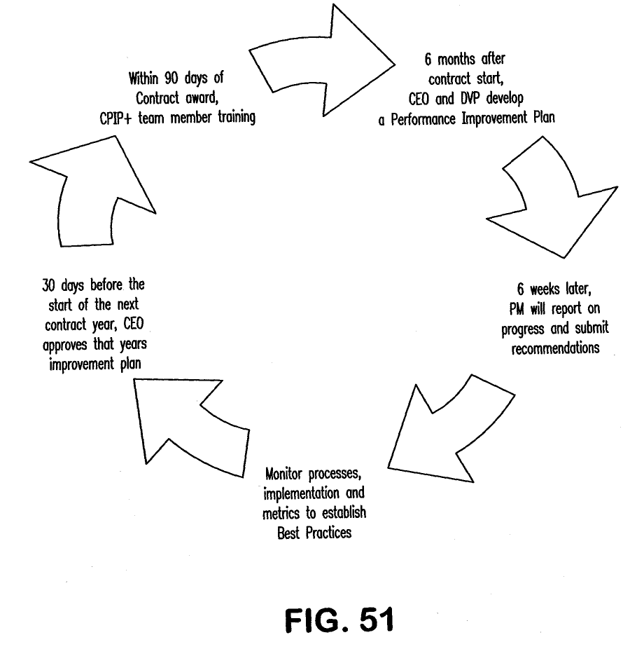

FIG. 51 is a block diagram of the timeliness and oversight features of the continuous performance improvement system in accordance with the present disclosure;

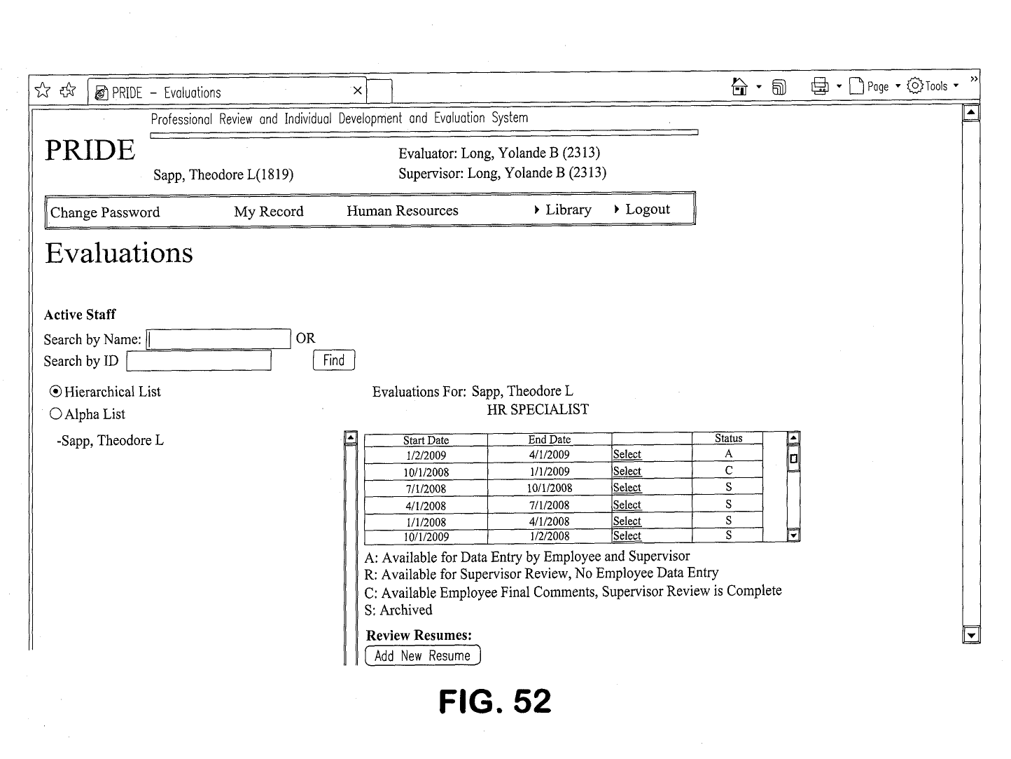

FIGS. 52-56 show exemplary individual development and evaluation system user interfaces in accordance with the present disclosure;

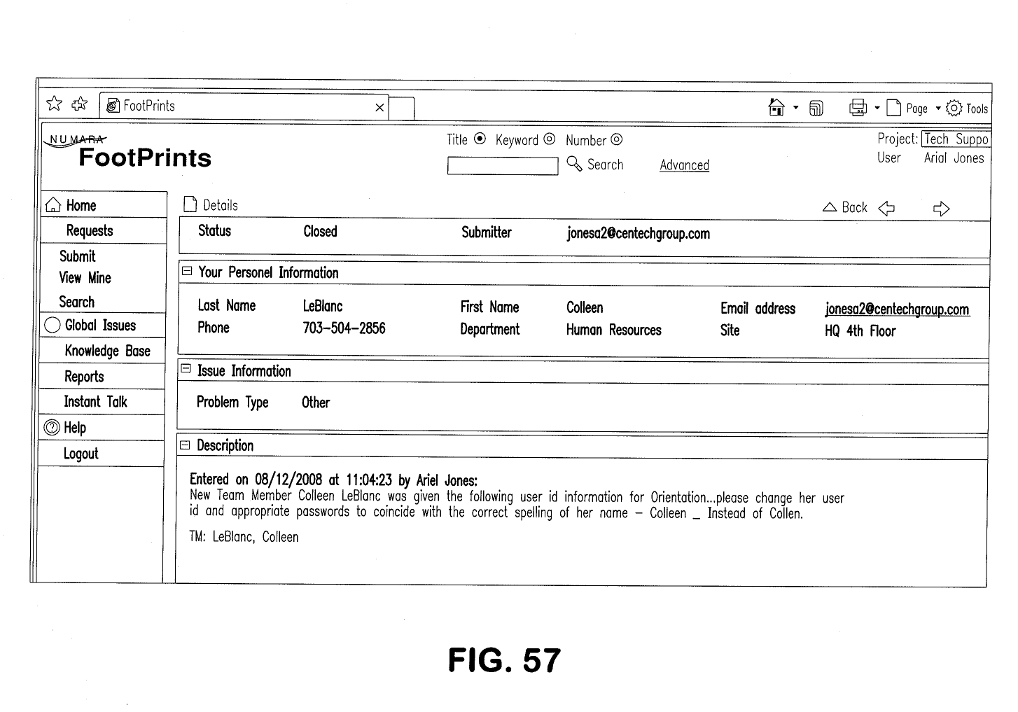

FIG. 57 shows an exemplary service support center user interface in accordance with the present disclosure; and

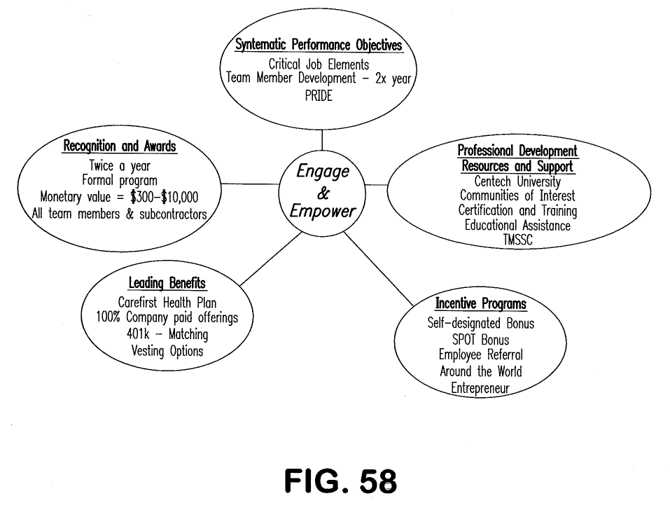

FIG. 58 is a block diagram showing an exemplary team member incentive and development program in accordance with the present disclosure.

### DETAILED DESCRIPTION

FIG. 1A is a block diagram of an exemplary embodiment of a system for continuous performance improvement in accordance with the present disclosure. In particular, a system 100 includes a computer-based continuous performance improvement system 102, which connects to one or more of a client 104, a client project management office 106, a project team 108 and project corporate entity 110. The continuous performance improvement system 102 is also coupled to one or more databases 112 (or data stores). The continuous performance improvement system 102 is adapted to produce deliverables 114. Deliverables 114 can vary depending on the associated project or contract.

The system, method and computer-readable medium disclosed herein can include modules adapted for the recognition and fulfillment of critical success factors. As shown in FIG. 1B, the modules of a continuous performance improvement system 102 can include Project Planning (116); Resource Allocation (118); Consistent Management Practice (120); Substantive Cost/Performance Reporting (122); and Timely Management Action on All Project Cost/Performance Variances (124). The modules discussed herein can be embodied as software instruction on a computer-readable medium (e.g., optical, magnetic or electrical data storage devices) such that a processor can be programmed using the software instructions and the programmed processor then performs operations for continuous process improvement described herein.

FIG. 2 is a diagrammatic illustration of exemplary stakeholders and their respective relationships to other stakeholders as connected by an exemplary system for continuous performance improvement. In particular, as used herein, stakeholders can include a person, organization or system that affects or can be affected by the implementation and outcome of a decision. Stakeholders may have an interest in the definition and implementation of a relationship. Also, the stakeholders may have a common interest in meeting and/or exceeding contract obligation(s).

A system in accordance with the present disclosure can include functions for processing data representing: 1) an understanding of the Stakeholders of each contract assignment, including knowledge of their jobs and responsibilities, their risks in doing their job, and their expectation of our contract; 2) a definition of what will meet Stakeholder expectations, including the contract quality objectives; 3) a definition of the “Value Opportunities” for all stakeholders and opportunities for improvement or benefit in the expectations of the stakeholders; 4) a definition of the Value Achievements, where Value Achievements include the successful fulfillment of the opportunity inherent in the management approach; and 5) a description of the processes, tools and techniques that enable Value Achievements.

An embodiment in accordance with the present disclosure can include one or more software management tools directed to meeting these objectives. The software management tools are adapted to help: 1) meet contract requirements by meeting agreed upon milestones and deliverables, through managing risks, and maintaining quality and professional standards; 2) achieve customer satisfaction by defining and documenting customer expectations and meeting or exceeding those expectations; and 3) seek to understand and fulfill the end user needs by seeking out a complete understanding of the client mission objectives and indentifying and providing critical perspective to best achieve mission objectives and ways to enhance such achievement.

Examples of stakeholders include End User, Acquisition Project Management Office (PMO), Corporate Entity, and Corporate Entity Team. The End User is the user of the product and/or services provided by the Corporate Entity using the management approach provided herein. The PMO defines the requirement and develops the performance objectives of the contract and product or service. The Corporate Entity promotes and invests in the partnership and ensures the availability of resources. The Corporate Entity Team includes Corporate Entity employees and Subcontractors.

The role/responsibility of the End User is to effectively perform their job to accomplish their mission. They must therefore identify the needs that would enhance their ability to perform their job. The following risks can be associated with the End User: they might not completely understand the mission; their needs might not be adequately identified, understood and communicated to the PMO; there could be a lack of awareness of opportunities for improvement; and there could be inability to effectively anticipate and fulfill changing mission requirements. End User expectations of contract outcomes include having the right product to effectively perform the job; having other stakeholders understand and respond to their needs; and having the opportunity to continuously view and impact the implemented solution during development.

The role/responsibility of the PMO is to correctly define and document the requirements to meet the End User needs; solicit and select the best vendor to satisfy the End User needs, and execute/manage the contract to fulfill documented requirements. The following risks can be associated with the PMO: incorrect or incomplete definition of the user requirements; Contractor fails to meet the contractual requirements; there is a lack of responsiveness or flexibility to meet the dynamic nature of the program; or there is a failure to identify opportunities to exploit process or technology that can enhance or better satisfy meeting mission objectives. PMO expectations of contract outcomes include meeting performance requirements; meeting scheduling requirements; and staying within budget.

The role/responsibility of the Corporate Entity is to fulfill contractual obligations in support of the mission and manage the contract in compliance with internal processes and procedures. The following risks can be associated with the Corporate Entity: failure to satisfy performance requirements; failure to achieve full customer satisfaction; failure to satisfy budget and schedule obligations; and failure to achieve profitability. Corporate Entity expectation of contract outcomes include meeting internal quality objectives; receiving positive references; and meeting profitability objectives.

The role/responsibility of the Corporate Entity Team is to successfully perform assignments in support of contract obligations; maintain and improve professional skills and capabilities; work as team players; demonstrate initiative and creativity; and maintain mission perspective. The following risks can be associated with the Corporate Entity Team: there could be inadequate understanding of job assignments; inadequate feedback and/or guidance; inadequate team or professional working environment; inadequate tools or training; inadequate access to current information and documentation; or lack of a career-oriented environment. Corporate Entity Team expectation of contract outcomes include a workplace environment that provides challenging assignments, consistent and positive leadership, right tools to do the job, encourages contributions/initiatives; and provides/promotes timely and effective communications; growth opportunities with achievement-driven career advancement and training and certifications support; and recognition including fair compensation, client recognition of achievements, management recognition of achievement, and professional/peer recognition of achievements.

As mentioned, a system in accordance with the present disclosure can include function for capturing and processing data associated with understanding and fulfilling end user needs, achieving full customer satisfaction, and meeting all contract requirements. Value possibilities are presented by these foundation objectives and can be realized through an embodiment of the continuous performance improvement method and system disclosed herein. The value possibilities include: 1) complete fulfillment, visibility and satisfaction; 2) continuously improve high quality service; and 3) engage and empower team.

Fulfillment, Visibility, Satisfaction

The fulfillment, visibility and satisfaction value possibility provides possibilities to meet all contract requirements, provide in-process visibility to work activities and products, enables continuous client feedback on project performance, understand and strive to meet client mission and expectations, each client trust, and attend to early course corrections.

The fulfillment, visibility and satisfaction value possibility includes four categories. These include: 1/a critical success factor-driven risk methodology; 2/an integrated team web-based workspace (PIMS); 3/a comprehensive performance management systems and tools; and 4/a customer satisfaction assurance process.

Critical Success Factor-Driven Risk Methodology

Components of category one, a critical success factor-driven risk methodology include creating a baseline through effective project planning, sound resource allocation, consistent management practice, substantive cost/performance reporting, and timely management action on all project cost/performance variances. Each of these components mitigates systemic risks inherent in projects. Risk management is segmented into systemic and non-systemic. Systemic risks apply to every project are fully predictable and are addressed by the process disclosed herein. Non-systemic risks are exceptions to normal process or standards. These risks uniquely require special attention and represent alternative paths/process for projects. To address all risks whether systemic or non-systemic PIMS (further described below) provides continuous access to risks, mitigation plans and management; deliverables and in-process working documentation; schedules, actions and status; quality plans and reports, and CM-controlled documentation.

One example of systemic risk is defective project planning. Examples of defective project planning include: inadequate understanding of customer requirements; inadequate breakdown of work into defined work elements with specific verifiable work product expectations; inadequate understanding of dependencies between work elements for their successful completion; inadequate detail of startup activities of the entire project or work elements within the project; unrealistic or insufficient detail in scheduling of work elements; inadequate definition of performance measures and performance objectives; inadequate quality control plan and/or incomplete risk management plan for non-systemic risks and mitigation. Elements of effective project planning include requiring all planning and estimating to be done based on business rules derived from past experience; requiring documented approach, detailed schedule, performance objectives, Quality Control (QC) plan, risk management plan, transition plan, and requirements; and/or independent QC verifying the project plan has been based on established company business rules.

A further example of systemic risk is defective resource allocation. Examples of defective resource allocation include: inadequate or incorrect breakdown of work elements into required skills and quantity of each skill; inadequate definition of the appropriate skill levels vs. schedule and work element; and/or inadequate assessment of ability to provide the necessary skills vs. subcontracting for the skills or subcontracting the entire work element. Elements of sound resource allocation include requiring all projects to use corporate experience based cost models for resource estimating; requiring skill requirements, skill levels, and quantity estimates to follow experience based business rules; requiring make/buy decisions be based on company skills inventory maintained in database, and subcontractor selection, where needed, sourced to pre-qualified vendors; requiring independent quality control verifying resource planning is consistent with our cost models and business rules.

A further example of systemic risk is defective project implementation. Examples of defective project implementation include: failure to consistently follow good management practice to implement the project plan; failure to provide adequate QC to monitor compliance with project plan; and failure to maintain full and current information sharing with client, staff and management including schedules, risks, deliverables, quality records, action status, meeting minutes and performance reporting. Elements of consistent management practice include defining Capability Maturity Model Integration (CMMI) Level 3 (L3) corporate processes, mandating consistency with plans, and requiring management approval of changes; requiring project manager monthly self-assessment of the project against InSight (or the project management assessment tool) criteria; maintaining a customer satisfaction assurance process that monthly requires project manager to share project self-assessments with client monthly, capture client comments or disagreements with the project manager self-assessment, and direct reporting of customer feedback to corporate management and quality assurance; and/or requiring full information sharing and collaboration within the project and with the client via PIMS, where PIMS includes schedules, risks, deliverables, quality records, action status, meeting minutes and performance reports. The project management assessment tool, as further defined below, includes independent quality assurance review and override of the self-assessment and enables quality assurance to escalate problems as necessary/CMMI or Capability Maturity Model Integration refers to a process improvement methodology used to help organizations improve their performance, products and services.

A further example of systemic risk is ineffective cost and performance reporting. Examples of ineffective cost and performance reporting include failure to define and report reliable performance data against predetermined quantitative objectives; failure to consistently report on status of non-systemic risks and effectiveness of mitigation plans; failure to provide management consistent reporting against checklists of performance standards for systemic risks (i.e., adherence to management approach and standards); and failure to consistently provide complete and timely reports to management on cost and performance. Elements of substantive cost/performance reporting include: cost reporting by earned value techniques (for completion contracts) with earned value credit earned only upon 100% completion of tasks, and all tasks measured against quantitative performance objectives; strict adherence to all cost and performance reports being available for monthly project reviews by the 10th workday of each month; complete review of risk management plan (i.e., non-systemic risk status) during each monthly management review; complete rating of project adherence to corporate management standards, supported by the project management assessment tool; and independent monthly quality assurance report provided to the entity management on each project.

A further example of systemic risk is failure to effect timely management action on variances. Examples of failure to effect timely management action on variances include inconsistent review of cost and performance reports; failure to define, document and track corrective action plans; failure to escalate persistent problems or properly assess problem consequences; and lack of visibility into variances from an approved set of performance standards. Elements of timely management action include: commitment to a monthly review of each project by appropriate management, (monthly review includes customer satisfaction process feedback, project management assessment tool report, earned value report for projects with a 0 or 100% credit for work elements (for completion contracts), risk management plan status, review of all corrective action plans and status, and quality assurance report); quality assurance escalates problems to the appropriate management when it is determined that corrective action plans are inadequate or implementation of corrective actions is unacceptable; management participates in all monthly reviews of projects with either cost/performance variances or with issues escalated by quality assurance.

FIGS. 3 and 4 are a flowchart showing an exemplary method for continuous performance improvement in accordance with the present disclosure. The steps of the method shown in FIGS. 3 and 4 can be implemented in a system having corresponding modules as disclosed herein. FIG. 3 shows a project planning phase. In particular, a request is received and a detailed plan is developed. A work breakdown schedule (WBS) and staffing requirements plan is developed. Specific staffing assignments are identified. Development of these plans and staffing assignments can be augmented by resources such as corporate standards, business rules, and cost models retrieved from a corporate experience database. Also, staffing can be assisted using a corporate “matchmaker” database designed to assign appropriate personnel to tasks. A task plan is documented. The task plan can be review by quality assurance. A work authorization is obtained.

FIG. 4 shows an implementation phase. In particular, a project is executed and is subjected to a customer visibility and satisfaction assurance process and an internal self-assessment process. Cost and/or performance status and risk management status are reported and tracked. Internal management reviews are conducted. Quality assurance has continuous visibility of the process and work products. Once release of deliverables is authorized, a delivery can be made.

Integrated Team Web-Based Workspace (PIMS)

Components of Category two, an integrated team web-based workspace (PIMS) include full disclosure and visibility, collaboration, version control, project documentation (work products, quality reports, etc.), and corporate portal for all Corporate Entity systems, policies, forms, processes, resources and help. PIMS provides continuous, real-time access to the project data. The system contains all critical program and task information, including: deliverables, project-specific work documents and templates, schedules, action assignments and status, risk management documents, performance objectives, and quality plans and reports. The content management structure can also serve as the central access location for further performance management systems such as the project management assessment tool and project performance manager system. This secure, web-accessible system: ensures client visibility into project work documents; allows clients to become an integral part of the contract implementation process; is a critical part of maintaining a productive and collaborative team environment; is version-controlled to time track document authors and file locking and changes; and captures historical documentation and metrics for future project planning.

PIMS therefore provides a project data repository and collaboration tool that supports the needs of project managers, project personnel, authorized client representatives, and corporate personnel. PIMS data represents the knowledge base of a project history, successes, best practices, and lessons learned. PIMS helps a project manager manage, track, and report on their project's day-to-day activities, performance and deliverables. In one embodiment, PIMS stores valuable project data organized in the following 12 folders: 1/Meetings; 2/Performance Objectives; 3/Risk Items; 4/Action Items; 5/Quality; 6/Deliverables; 7/Controlled Library; 8/Working Documents; 9/Discussion; 10/Address Book; 11/Client Confidential; and 12/Proprietary. Each will be discussed in an exemplary fashion.

PIMS stores minutes of meetings and other relevant meeting data providing a full historical record of decisions and events. A full-text searching capability is available for returning historical data plus data can be stored in any application format.

Related to Performance Objectives: In any project there will be two types of performance objectives, those defined by the Corporate Entity and those required by the client. Contract specified Service Level Agreements (SLAs) are an example of client required performance objectives.

Risk Items: A component of the Project Management methodology disclosed herein is the identification, monitoring, and mitigation of any risk item that can affect a project's performance, schedule, or cost. Once the risks are identified, PIMS can rank each risk according to its probability of occurrence and the potential severity of its impact. The PIMS data repository also provides project managers with historical data on the mitigation of similar risks providing them with insight into causes and methods for avoiding or mitigating potential risks.

Action Items: This PIMS folder is where a project manager defines, monitors, and closes their project action items. Once an action item is created, PIMS has a reminder feature that alerts the project manager of pending due dates.

Quality: PIMS was designed to provide a Quality Assurance (QA) approach that complies with the SEI Capability Maturity Model and Integration (CMMI). This folder is used to define plans, checklists, and records that inform project staff of the project's QA objectives plus it can contain the project's QA Evaluations used to monitor the project's adherence to plans, policies and procedures.

Escalation procedures in PIMS ensure that all levels of management are involved and responsive to achieving and maintaining project quality and integrity.

Deliverables: Project deliverables can be managed using PIMS. For each deliverable a planned and actual release dates of the deliverable with milestones can be established. Over the course of the project, PIMS captures data that measure the project team's performance on meeting their deliverable schedules.

Controlled Library: During a project there could be certain documents that must to be controlled by Corporate Entity or the project's client. This folder provides the mechanism for controlling who can modify a document.

Working Documents: In some cases during a project, certain documents and deliverables are in-progress but not yet part of the controlled library. This folder stores documents that are not yet placed under configuration control.

Discussion: This folder provides a message board for project, Corporate Entity, and client personnel can initiate and engage in an online ongoing discussion. PIMS organizes these discussion threads by topic.

Address Book: The address book folder provides a contact data repository for any individual that is involved directly or indirectly with the project.

Proprietary: This folder supports the exchange of confidential project data between authorized Corporate Entity personnel. Examples of items that can go in this folder include relevant corporate experience, best practices, commendations, awards, special recognition, and significant accomplishments.

FIG. 5 is a block diagram of an exemplary web-based workspace in accordance with the present disclosure. In particular, a web-based workspace (e.g., PIMS) is adapted to collaboratively permit clients to provide oversight and contribution. The web-based workspace can received program inputs, such as work documents, deliverables, quality records, performance objectives and risk items. The web-based workspace can provide program output such as interest groups, lessons learned, processes, templates and deliverables. The web-based workspace can permit a quality assurance organization or group to access auditable artifacts and records, assessments, evidence of QMS compliance and corrective actions. The web-based workspace can also permit a corporate entity to exchange processes, instructions, guidelines and templates.

FIG. 6 is an exemplary user interface for the web-based workspace system shown in FIG. 5. In particular, FIG. 6 shows a user interface 600 including a control for accessing each of the following project documents: meetings, performance objectives, tasks, quality, risk items, deliverables, controlled library, working documents, general discussions, address book, client confidential and proprietary. Also, the user interface 600 includes control elements for accessing pictures, lists, discussions and surveys.

Comprehensive Performance Management Systems and Tools

Components of Category three, comprehensive performance management systems and tools include project performance manager system, customer feedback report system, contract deliverable management system, and financial reporting system. In one embodiment, the quality management system (QMS) conforms to the ISO 9001/2008 standard, is externally audited semi-annually, and requires demonstrated continuous performance improvement. The QMS ensures: operational effectiveness through detailed management processes, achievement of complete customer satisfaction and confidence, and company-wide compliance with Quality Policy.

FIG. 7 is diagrammatic illustration of an exemplary process for receiving customer requirements as input and monitoring customer satisfaction in accordance with the present disclosure. In particular, a process 700 includes receiving customer requirements 702 as input and applying resource management 704, management responsibility 706, measurement, analysis and improvement techniques 708 and product/service realization 710 in order to generate customer satisfaction 712.

FIG. 8 shows an exemplary user interface 800 for a project management assessment tool in accordance with the present disclosure. The project management assessment tool (e.g., InSight) is adapted to display critical project-level information for all management levels. The project management assessment tool provides: a comprehensive, monthly performance assessment against defined quality objectives and performance metrics; a thorough evaluation of performance indicators which include the results of the Self-Assessment Customer Feedback Report; a disciplined process to improve quality and program performance; and a proactive identification of potential problems so that corrective and preventative actions may be initiated.

Further, the project management assessment tool can include: Entity internal project assessment system; project managers review critical elements monthly; ensures project compliance with Entity management system; provides senior management a systematic review of project performance including increased monitoring allows earlier risk identification and corrective actions, leads to timely management action on items of concern, separate categories for technical performance, quality, schedule, financial, and personnel items; and quality review of performance trends. The project management assessment tool provides management visibility into project data entries and management view of assessment scores.

In one embodiment the project management assessment module makes use of the following technologies: Windows Server 2003, Visual Studio 2003, Net Framework Version 1.1, Language: C#.NET, and SQL Server 2005. Functions/rights of the module include: view summary (of monthly assessment); view data; add data; and assess the project. A login page is not necessary as the system can browse from the portal site.

Elements of the home page within the project management assessment tool can include: display the logged in user name and the system functionality level, colored indications as to expiration dates, an assessment summary, a link to the customer satisfaction library, and the option to view data across multiple projects, as defined by the selection of division, program, resource center on the top of the page, a data screen showing reverse chronographically all data entered (and impact, etc) for any project within the selected set of projects—with the ability to further filter viewed data.

Elements of the project list page within the project management assessment tool can include user selected filtering of data to display a project list with assessment summary, project details of the displayed project also shown on screen, a link provided on the project name such that when selected the related summary is shown.

Elements of the project summary page within the project management assessment tool can include for example: a summary for a set period such as last three calendar months, a Trend Button or hot link for the specified category as well—where by selecting the button a user can view the last 12 months trend in a new window and the window includes “Previous” and “Next” buttons, links are provided on to display item wise assessment within the category, nonactive categories color coded, assessment summary of selected time period displayed, and a hot link or button to copy a prior month assessment and provide in current month.

Elements of the project data entry page within the project management assessment tool can include for example: a listing of category, item and impact selectable by user, once selected user can enter data for that category, “Save” and “Next button/hotlink functionality included, search functionality included, multiple file uploads allowed with data, impact can be designated by color.

Elements of the project assessment entry page within the project management assessment tool can include for example: a listing of category, item and impact selectable by user, once selected user can enter data as sell as assessment with description, search functionality provided in data list, data and assessment provided with differing visual/look, and colored indication for soon to expire items.

The project management assessment tool further provides customer feedback functionality. A user can select a Program/Resource Center or Project and click the “CFR” button to open the customer feedback form. The system will open the latest form for the selected Program or Project. If no form exists the system will open a new form. Elements can include: links to display history over specified time periods, the option to include multiple attachments, corrective action plans, customer satisfaction trend report and reminder capability. Further capabilities related to these and other elements are disclosed elsewhere herein.

FIG. 9 is a block diagram of an exemplary project performance manager system in accordance with the present disclosure. The project performance manager system is a comprehensive program and project performance evaluation tool for both Client and management. This tool provides a hierarchical program set up; comprehensive, monthly performance assessment against contract-unique performance metrics; client visibility and participation in performance measurement and management; disciplined process to improve quality and program performance; and proactive identification of potential problems so that corrective and preventative actions may be initiated.

In particular, FIG. 9 shows a hierarchical program structure 900 including a program level 902, a resource center level 904, a project plan level 906, a project level 908, one or more groups 910, a category set 912, one or more categories 914, one or more items 916 and assessment and data 918.

Within the hierarchical program structure 900 of the project performance manager system, the top level is a Program and the bottom level is a Project. The hierarchy can be changed for each Program. The resource center, plan and group levels are optional and can be given a different name. Groups spans across the multiple resource centers and plans but are unique to the particular Program. The hierarchical program benefits entity and client management enabling collaboration on design of an organizational structure that meets client's functional and management needs. The program further provides entity and client management with top-down view of performance ratings and project data, and displays actual project and selected program subset roll-up scores to provide insight to key functional areas over the period of performance.

The project management assessment tool can provide monthly performance assessment against contract-unique performance metrics. Attributes include: categories that are grouped under a category set, and are used in generating the monthly report of an aggregated set of projects; categories and items that are specifically defined for each program; unique, weighted evaluation criteria for each program are created using Yes-No, numerical and threshold standards; programs aggregate scores from one or more subordinate levels to assess performance; and resource centers aggregate scores from one or more project plans to assess performance.

Performance Manager System (PMS) can be built upon to significantly expand the features and capabilities of the project management assessment tool. For example, the PMS application can be independent from the project management assessment tool and yet have the features of the project management assessment tool available for the PMS application. Also, Groups can have projects existing under different plans and provide reports for a plan+group combination. Evaluation entities can be a project and an Item. Other entities will get aggregated data for reporting from these two entities. As user drills down to a particular project and then to an Item, the user has the ability to select a month, and can open, edit (if Program month not completed, and the user's permissions allow) and see all attachments and comments.

Levels of hierarchy can be similar to those of the project management assessment tool. For example: Program→Resource Center(RC)→Plan→Project, where a Group can span across the multiple Plans and Resource Centers. The Top level will typically be a Program and a last level will typically be a Project. The hierarchy can be changed for each Program. Resource Center and Plan Level can be optional and can be given a different name. Category and Items are the always defined for each program and Items are always under the category. Category Set and Groups are also unique to the Program. In other words each program can have a separate set of groups and Category sets. The table below provides exemplary description of some terms:

| Term | Definition |
|---|---|
| Program | Highest Level in the Program Hierarchy |
| Resource | Second Level comes under the Program |
| Center (RC) | |
| Project | Third Level comes under the RC |
| Plan (PP) | |
| Project | Lowest level in the hierarchy; which needs to be |
| | evaluated/rated |
| Items | Entity against which project will be evaluated/rated |
| Categories | Items can be grouped under the category |
| Category | Categories will be grouped under a Category Set, and |
| Set | is used in generating the Monthly Report of an |
| | aggregation set of projects. |
| Reporting | Reporting period is the period for which user wants to see |
| Period | the evaluation data. In other words, it decided the number |
| | of columns/months on the screen. Also weighting can be |
| | setup for a reporting period. |
| Transition | Transition Period is a period to adjust 1st reporting |
| Period | period start date, to allow the transition period to have |
| | a number of months different (but not greater than) |
| | from the standard program reporting period |
| Group | Group is an attribute to the Project. Groups are |
| | independent in the hierarchy. |

FIGS. 10-14 show exemplary project performance manager system user interface screens in accordance with the present disclosure. FIG. 10A shows a setup screen example in which a user can configure options including: reporting period, transition period ending day, thresholds (having a selectable number of thresholds each with an associated value range), a levels setup section (for example, with four levels and a group level), a cancel button and a save button. FIG. 10B shows a role details screen showing role name, group, and a level for each of viewing data, entering data, entering assessment, viewing summary and options for view in report, organizational level. For each role, an edit and a delete interface element is provided. The edit element can be selected to edit any of the above details. The delete element can be used to delete a particular role associated with the delete element.

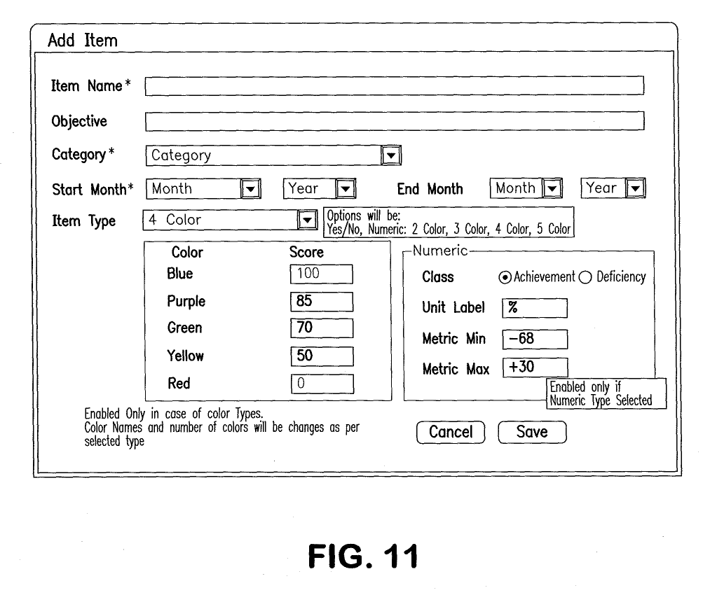

FIG. 11 shows a user interface for adding items. The user interface includes elements for specifying the details of an item including: item name, objective, category, start month/year, end month/year, item type, level score corresponding to each applicable level color, numeric information such as class unit label and metric min and max. The user interface also includes elements for canceling or saving the item data on the screen.

Projects can also be added using an interface similar to that shown in FIG. 11. The add project interface can include user interface elements for specifying project name, project ID, WBS code, group, plan, start data and end date. Plans can also be added using an interface similar to that shown in FIG. 11. The add plan interface can include user interface elements for specifying plan name, WBS code, plan year and resource center. Resource center can also be added using an interface similar to that shown in FIG. 11. The resource center add user interface can include elements for specifying resource center name, resource center ID, WBS code, and program.

Groups can be added using an interface similar to that shown in FIG. 11. The group add user interface can include elements for specifying group name and WBS code. Program can be added using an interface similar to that shown in FIG. 11. The add program user interface can include elements for specifying program name, program ID, WBS code, start date and end date.

Categories can be added using an interface similar to that shown in FIG. 11. A category add user interface can include elements for specifying category name, category abbreviation, and category set. A category set can be added using an interface similar to that shown in FIG. 11. A category set user interface can include an element for specifying category set name.

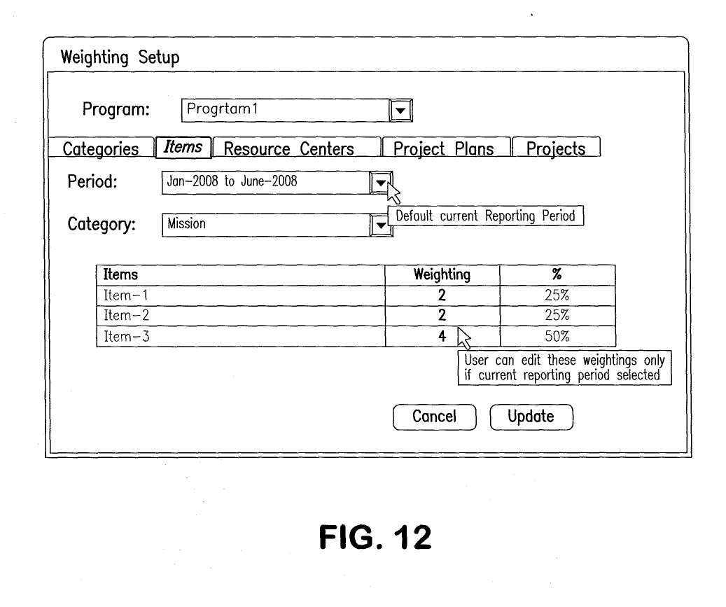

FIG. 12 shows a weighting setup user interface including elements for specifying a program, category tabs, period drop down, category drop down, item name and editable weighting fields, a cancel button and an update button. Pressing the update button causes the values in the weighting setup user interface to be stored.

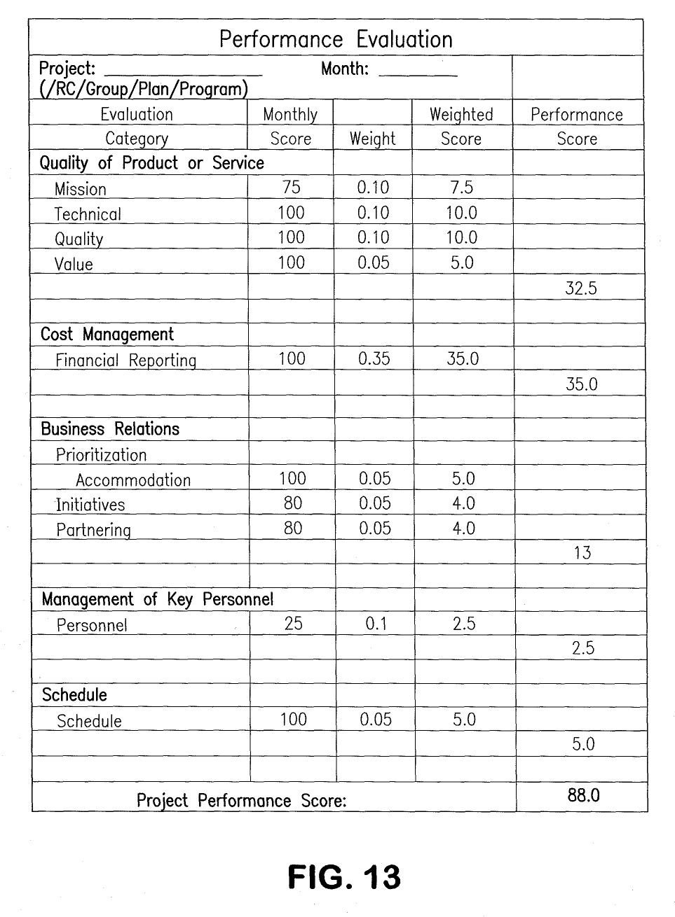

FIG. 13 shows an exemplary performance evaluation report showing product evaluation categories and scores (e.g., monthly, weighted, performance and project performance).

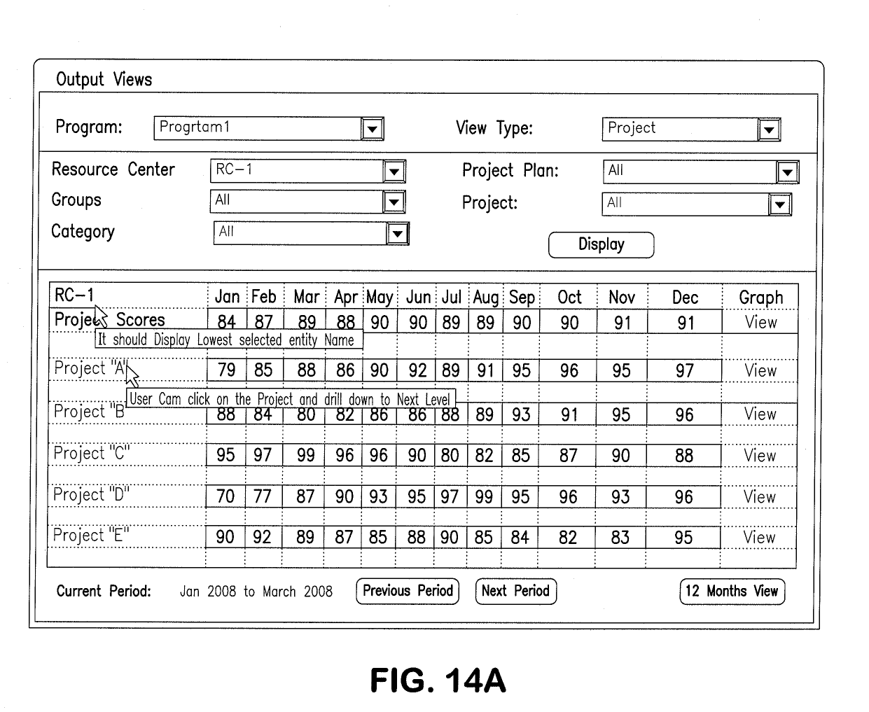

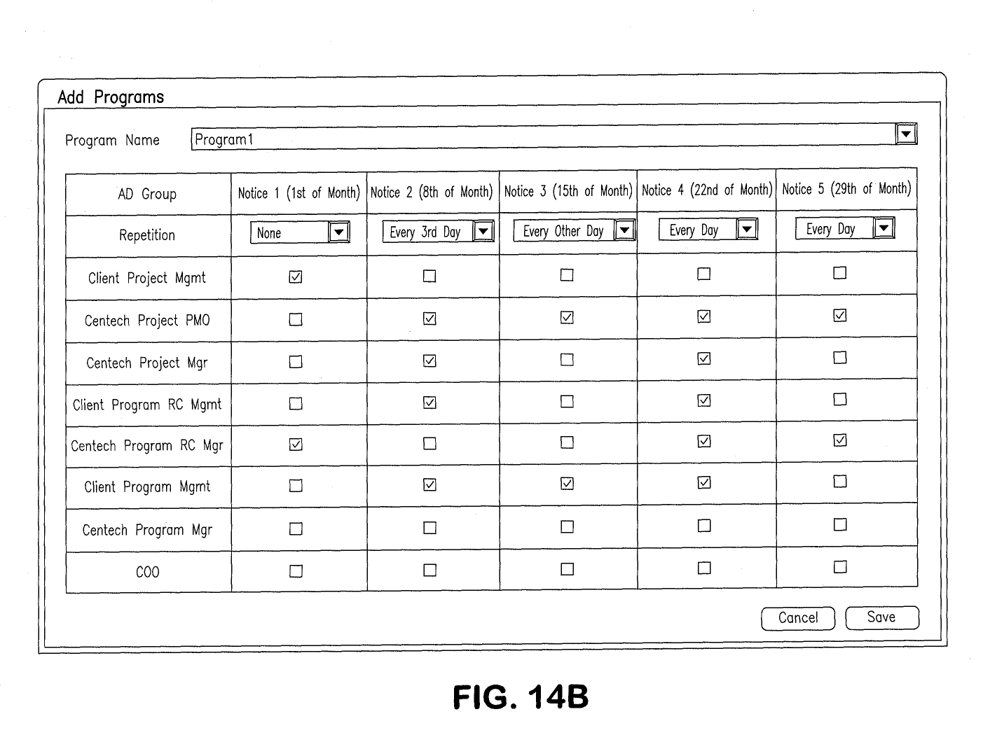

FIG. 14A shows a tabular output performance viewer screen in which a user can select a program and view type and performance data will be presented in tabular form as shown in FIG. 14, which includes, for example, project scores for Projects “A”-“E” for the months of Jan.-Dec. Data can also be viewed in a graphical format by selecting the “view” options shown under the Graph column header. The user interface includes button for previous period, next period and 12 months view.

The project performance manager system further provides client visibility and participation in performance measurement and management. With this tool transition periods can be created to bridge the first reporting period start date to the standard program reporting period; client management can drill-down to the item level to view assessments, project data and attachments; client can submit comments and attachments; tabular and graphical displays of project performance provide trend analysis. The project performance manager system further provides a disciplined process to improve quality and program performance, including tailored evaluation criteria created for key deliverable milestones and client benchmarks; client comment inputs related to performance assessment establishes concurrence with actions and priorities; defined organizational hierarchy ensures improved client oversight of common projects; and automated email notification alerts managers to evaluation deadlines. The project performance manager system further provides proactive identification of potential problems so that corrective and preventative actions may be initiated, including graphing and tabular displays allow for trending analysis and stakeholder visibility into system promotes deficiency identification.

FIG. 14B shows an exemplary mail and reminder setup user interface in which a program name can be specified and reminder for each AD group can be specified using the elements on the user interface. Notices (e.g., on the 1st, 8th, 15th, 22nd and 29th) can be set to a repetition period (e.g., none, every 3rd day, every other day, every day, or the like). The user interface includes cancel and save buttons.

FIGS. 15-16 show exemplary contract deliverables user interface screens in accordance with the present disclosure. Contract Deliverables is an application which details contract deliverable requirements and delivery. The system includes: contract deliverable description and due date attachment of non-classified deliverables that satisfy the contract requirement; date stamp of the deliverable submission; record of deliverable acceptance or rejection status (if any) and actions; automatic email notification of upcoming deliverable due dates; and structured tracking of deliverable requirements and schedule. Benefits of the contract deliverables application include reducing the likelihood of missed deadlines; escalates failure to submit deliverables to senior management; and easy access and visibility provides for efficient review and audit.

In particular, FIGS. 15 and 16 show a contract deliverables user interface in which contract deliverable details can be added and/or changed. There are user interface elements shown for specifying new or different details such as account code, CLIN, CDRL, due date, deliverable name, NCD, CDD, delivery status details (delivered to client indicator and status indicator), acceptance status details such as client assessment, rejection status, remarks and remarks history. The user interface also includes cancel and save buttons.

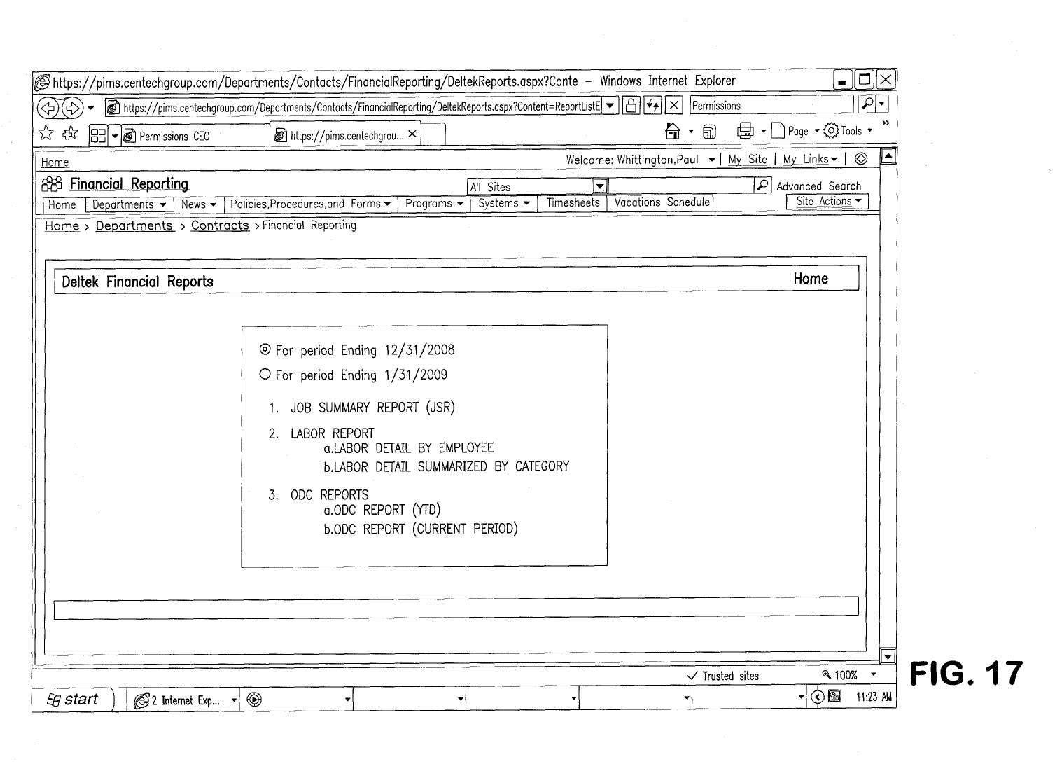

FIGS. 17-19 show exemplary financial reporting user interface screens in accordance with the present disclosure. The financial reporting module can be implemented, for example, by a Deltek-supported system that provides Entity management with the current financial status of a defined organizational project set. Financial details provided include: job summary reports; labor reports (by individual and labor category); and ODC Reports (by year to date and current period). ODC refers to Other Direct Cost, these reports contain direct expenses that support a particular contract, to include items such as travel, lodging and supplies. Benefits of FinancialReports include: 24/7 access to project financial data; comparison of actual charges against budgeted; and user-defined roll-up criteria for evaluation.

In particular, FIG. 17 shows a user interface for selecting a period and a type of report. FIG. 18 shows an exemplary Job Summary Report for a specified period. FIG. 19 shows an exemplary Labor detail report.

As one exemplary embodiment, a Deltek supported system such as referred to above written in the C#.NET programming language, using a Share Point Portal Server 2003 as a platform, and a .NET Framework 1.1, and SQL Server 2005 Reporting. The work breakdown structure is: 1/level one—contract; 2/level two—job order number; 3/level three—fiscal year; 4/level four—resource center; 5/level five—project plan; 6/level six—group; and 7/level seven—project. The reports main screen provides an input screen to allow users to select all entities as given screen shot. The data can come from applications such as the project management assessment tool. The report selection page can display a report list including for example: job summary report; labor report with labor detail and/or labor detail summarized by category; ODC (other direct cost) reports including for example a year to date report sorted by suffix and transaction code and/or a current period report. The user can select a report and view the reports.

FIG. 20 shows an exemplary web-based trouble ticket user interface screen (e.g., TMSSC) in accordance with the present disclosure. The Team Member Support Services Center (TMSSC) is a web-based trouble ticket application that provides 24/7/365 technical support to all Entity team members. The TMSSC system provides: increased accountability and responsiveness to employee needs; tracking of requests; and trending statistics to improve corporate processes and infrastructure support.

In particular, FIG. 20 shows an exemplary trouble ticket or support request tracking system. Any trouble ticket system providing the function described herein could be used.

The TMSSC home page displays a list of requests. For the normal user/requestor it will list his/her own requests and for the technician it will display his/her department's requests. Also user/technician can use search criteria to filter the request list. The following sample elements can be included: 1/When user adds requests, no technician is assigned to the request; 2/TMSSC administrator can assign technician for any requests; 3/Technician can assign a request to himself/any of his colleagues; and 4/in the home page the technician can view all requests from his department, items designated as “My tasks” are all requests where he is a technician, items designated as “All” include all requests for his department whether assigned to him; to his colleague or not yet assigned, items designated as “My Request” are all personal requests. The following search criteria can filter the record in the request list grid (available search criteria can vary by user): request for-dropdown, this can include my requests, my Tasks, or all; status-drop down, this can include resolved, on hold, work in progress & re-opened, or cancelled; department-drop down; and/or technician-drop down. The requests list can display the following columns search criteria: requestor name; request priority; assigned to; status; created date; resolved date; and edit/view—this link button can redirect to add/edit request page. The following buttons or hot links can be available: add request, print/export button, and admin button. For example, add request can be used to add an accounting request, add a human resources request, add an information technology services request, or add an administration and facilities request. On the click of the add request button, an alert screen can be opened. Alert screen are opened only if any alerts are created/opened, otherwise an add request page is opened. The print/export button will cause display of SQL Reports and present the same information as on the screen, sort by dropdown can be provided. Such sorting can be by date/time in reverse chronological order, by department in alphabetical ascending (a to z) order, or by technician in alphabetical ascending (a to z) order. The admin button allows administrative staff to navigate to administration areas of the application.

When a requestor clicks on “Add Request” button for any Department, an alert screen is displayed first with Cancel and Continue button. The user can navigate to the actual Add Request Page by clicking on the Continue button. The Alerts screen is avoided if there is no active alert for the department. The alert list is displayed in reverse chronological order—latest first. This screen contains all the Active Alerts with three columns: Alert Description, Created By, and Created Date-Time. Below the grid two further buttons/hot links are displayed: Continue allows navigation to the add request page, and Cancel allows navigation back to the home page.

The Add/Edit Request Screen provides a means to add, edit or revise a request. Fields can include: 1/request number; 2/request date/time; 3/requestor's name; 4/requestor's phone number; 5/location; 6/priority/importance; 7/request type; 8/request item; 9/description; 10/technician assigned to; 11/request status; 12/remarks; 13/remarks history/event log; 14/resolved by; and 15/resolution date time. Should a requestor click on “Re-Open Request” the button status will be changed to ‘Re-opened’. This button will be enabled only if request status is resolved. Should a Requestor click on “Cancel Request” the button status will be changed to “Cancelled”. This button will be enabled only if request status is NOT Resolved. The technician cannot change the Status to ‘Cancelled’ or ‘Re-Open. Requestor can not change the status from the status drop down. Hot links or buttons on the Add/Edit Request Screen include: save button, to save the changes and navigate back to home page; cancel button to discard the changes and navigate back to home page; re-open request to allow the user can re-open his own request, the request status will be changed to ‘Re-Open’; and close request to allow the user to close his own request, request status will be changed to ‘Cancelled’.

Admin-Alert maintenance is a page used by administration and technicians to add/modify alerts. Search criteria to filter the record in the Request List Grid can include for example status and department. Elements in the alert list can include: alert description, department, status, activate/deactivate, edit, created by, and created date. Add Alert can be provided as a button or hot link. When a user clicks on the Add Alert button or edit link button from the Alert List. This area will be displayed on the top area of the page. Fields can include: department, status, alert description and save/cancel.

Administrative screens can also be provided for: department/category, request type, and request item. Request types and request items list can include: 1/accounting such as payroll (short paycheck, benefit options, deduction details or duplicate direct deposit), expense reimbursement (travel advance, travel expense reimbursement, or local travel reimbursement) or timesheet (password reset, leave balance, do not see assigned charge number, expired charge number); 2/human resources such as benefits (health insurance/prescriptions, dental insurance, life insurance, disability insurance, vision insurance, flex spending, tuition/training, 401K, or leave); 3/Information Technology services such as hardware (new workstation, move desktop, reimage desktop), applications (install new application, cannot use application), printers (cannot print, need toner, or install printer) network access (new account, access rights); 4/facilities & administration such as move desk, move PC, heating and air conditioning, cleaning, phone assignment, packaging and mailing, office supply, copy and printing.

FIGS. 21-24 show exemplary customer satisfaction assurance process user interface screens in accordance with the present disclosure. The customer satisfaction assurance process (CSAP) can include the reporting and tracking of actual project performance and customer satisfaction through the Self-Assessment and Customer Feedback Report (SACFR). This requires periodic reviews with the client on key objectives such as: customer satisfaction, performance, cost control, risk management and quality. Benefits include monthly evaluation identifies performance issues before they become problems; client feedback is immediately available to senior management for review and action as required; client involvement in root cause analysis and corrective action definition ensures concurrence in resolution decision; and Entity demonstrates ownership of improvement initiatives.

The process is as follows: relevant data is collected and analyzed by the Project Manager (PM); performance details and status of corrective actions are recorded on the SACFR; SACFR is presented to the client for their input at monthly meetings; PM and Client collaboratively develop root cause analyses and corrective action plans for all deficiencies; Identify and discuss Entity improvement initiatives; Client closes completed corrective actions; division VP reviews and verifies completed report, providing own remarks; and completed SACFR is submitted to Entity senior management for review

Customer Satisfaction Assurance Process

Components of Category four, customer satisfaction assurance process include formal monthly review of project performance against quality objectives, collaborative identification of improvement initiatives, development of root cause analyses and corrective action plans, executive review, client communication, and action to achieve corporate quality objectives.

The Customer Satisfaction Assurance Process ensures that a Project/Task Manager regularly reports overall project performance and preventive and corrective action plans, and all levels of management above the Project/Task Manager have these reports along with specific client feedback. Exemplary user interface screens for the Customer Satisfaction Assurance Process are shown in FIGS. 21-24. This process provides quantitative assessment of performance on each of the 10 categories of service quality designed to monitor effective achievement of corporate Quality Objectives. The Customer Satisfaction Assurance Process includes the means for documenting Corrective and Improvement Action Plans by the Project/Task Manager to bring greater value-added services to the client. It is through such initiatives as generated through the Continuous Performance Improvement Partnership program (CPIP) the project team may find new ways to deliver increased value across the scope of the 10 categories of service quality. The Project/Task Manager will fully utilize the process to inform the client of current and proposed Continuous Improvement initiatives and solicit their input or contributions to the effort. This process is intended to foster meaningful communication and a partnership between corporate management and their client counterparts, identify potential issues, ensure timely agreement on project status and action plans, and provide earliest possible opportunity for effective preventive and corrective action.

For example, a Division Vice President can be responsible for compliance with this process by all projects that report to the Division Vice President. In the event of projects that are tasks under a corporate contract and are primarily performed by a subcontractor, a corporate contract Program/Task Manager shall be responsible for performing this process, and in such cases reporting results into InSight will not be necessary since project management assessment tool only contains projects for which the corporation has primary performing responsibility.

The Customer Satisfaction Assurance Process includes the following sequence of activities through the utilization of the Customer Feedback Report application found in PIMS: 1) Completion of a Monthly Self-Assessment and Customer Feedback Report (SACFR) (there may be one or multiple reports depending on the size and organization of the project). The Project/Task Manager responsible for the work performed for the client completes this report, or the Division Vice President in his absence. 2) Update of the Corrective and Improvement Action Plan (CIAP) for the project. 3) Presentation of the SACFR and CIAP to the client and discussion with the client. 4) Markup of the SACFR and CIAP by the client. 5) Revision of the CIAP, as necessary, to address client concerns and disagreement, and capture of comments by the client of the changes to the CIAP. 6) Project/Task Manager submission of the report to and discussion with the Division Vice President. 7) Division Vice President contact with the client to discuss the assessment and corrective action plans. 8) Division Vice President enters client contact information on the CIAP and revises action plans if required and discusses with the project manager. And, 9) Division Vice President submits the final SACFR and CIAP by the 10^{th} of the month following the end of the month assessed.

The Monthly Self-Assessment and Customer Feedback Report (SACFR), shown in FIG. 21, delineates ten specific performance categories. The Project/Task Manager assesses project performance on a scale of 1 through 5 for each category and provides supporting information in the “PM Comments” field. Each category is assessed based on various factors, some of which are illustrated in FIG. 21.

The Project/Task Manager also fills out a Corrective and Improvement Action Plan (CIAP) that defines root cause determination, specific actions, status, and planned completion dates for planned actions to initiate preventive measures, correct deficiencies or improve performance. Any category receiving a score less than 5 requires a root cause to be established and the collaborative development of a corrective action plan with the client. A root cause is defined as the most fundamental reason for the failure or inefficiency of a process or occurrence of a problem.

The action plan must carry the open actions from the prior month as well as any new actions required based on current performance. For actions to be closed, they must be annotated as closed on the CIAP.

Within each project, there are opportunities to find new and better ways of improving quality service to the customer. The 10 categories of service found on the SACFR cover the entire spectrum of project-related activities and are all considered potential areas for improvement. Innovative measures can be implemented to both sustain optimum performance as well as redefine the highest standards of success.

The Project/Task Manager is expected to develop continuous improvement initiatives which will maintain high customer ratings and find areas where a value-added benefit may be incorporated into the service provided. Each Project/Task Manager will develop and execute two initiatives per year that are designed to raise a category assessment to a score of 5. In the case when all categories are assessed a 5, an initiative must be developed to provide a value-added service to the customer. Initiatives must include an action plan and once presented to the client, its progress must be documented in the CIAP each month until completion.

The Project/Task Manager will utilize all programs to promote Team Member involvement in the Continuous Performance Improvement Partnership program (CPIP). These programs are found within the Team Member Performance Enhancement and Motivation Programs and the Team Member Incentives Program. Each project member should consider themselves involved in the CPIP and actively seek ideas for service improvement.

The Project/Task Manager will meet with the client and discusses the self-assessment and action plan. Client comments are documented during the meeting and any disagreements are noted. The Project/Task Manager then updates the action plan and obtains customer comments on the revisions. The Project/Task Manager then forwards the completed form to the responsible Division Vice President. It is important that the submitted reports, root cause determination and resultant corrective action plans are the originals submitted to the client so that the handwritten changes or information entered by the client is clearly visible, and so that the Project/Task Manager CIAP changes made after client discussion are discernable. If approved by the responsible Vice President, the Project/Task Manager may enter the client feedback for the client based on verbal discussion with the client and initialed by the Project/Task Manager to that effect. Such exceptions are only permitted if the Division Vice President has exhausted all possibilities for direct client entry of feedback on the forms. In any case, the Division Vice President contacts the client to ensure full mutual understanding of project status and action plans, approves or modifies the action plans, completes his section of the CIAP and forwards to the President/COO by the 10^{th} day of the month following the month evaluated.

Continuous Improvement of Service

The possibility to continuously improve high quality service and value provides the opportunity to demonstrate continuous improvement in performance over the contract life; adhere to sustainable well-documented processes that are compliant with Industry standards and best practices (e.g., CMMI, Project Management Institute (PMI), International Organization for Standardization (ISO), Information Technology Infrastructure Library (ITIL)) implement repeatable successful processes; improvement initiatives to deliver value-added service; define performance requirements and expectations in measurable terms for reporting and trend analyses; and responsively manage the program based on timely and effective quality control, monitoring, and problem escalation to minimize program risks (including identify, track and close preventative and corrective actions; timely problem identification and escalation and independent audits (internal and external)).

The continuously improve high quality service value possibility includes four categories. These include: 1/Processes Compliant with Industry Standards; 2/Comprehensive Performance Management; 3/Quality Assurance Validation and Escalation; 4/Comprehensive Risk Management, and 5/Institutionalized Performance Improvement Processes.

Processes Compliant with Industry Standards

Components of category one, processes compliant with industry standards include Entity-approved processes, templates, and forms; performance improvement; process improvement requests; and regular Software Engineering Institute (SEI)/ISO appraisals and audits.

FIG. 25 shows an exemplary user interface screen for accessing libraries and repositories of process descriptions, procedures, templates and forms in accordance with the present disclosure. Examples of Entity-approved processes, templates, and forms include the use of Entity process asset library to provide project management, monitoring and execution assets; and instituting CMMI/ISO practices document configuration, change and revision management, process flow, operating procedures and process improvement. The process asset library is an organized, well-indexed, searchable repository of process assets that is easily accessible by anyone that needs process guidance information such as examples, data, templates or other process support materials. A process asset is any process guidance, in whatever form, that an organization believes is worth investing in and evolving or storing, and that the organization expects will provide a return on investment that makes it worthwhile to store and/or evolve the asset. Performance improvement includes use of Entity processes and quality management systems that contain specific performance expectations to ensure: intended activities to meet quality objectives, results are measurable and verifiable, and management visibility to enable effective quality management. Process improvement requests are available to all stakeholders, provide defined process improvement request procedures that involve Entity process group and process owners, and approval and verification of PIRs ensure requests are applicable, effective, and worthy of inclusion to process assets to be used by other stakeholders. PIRs stand for Process Improvement Request, these propose an improvement or creation of a process based upon an identified deficiency that may lead to a problem. In other words, PIR is a recommendation to or by a Process Owner to identify, analyze and improve existing corporate processes within the Corporate Entity to meet new goals and objectives. They may be used to suggest a new process. These requests often follow a specific methodology or strategy to create successful results. Regular SEI appraisals include periodic appraisals performed in accordance with CMMI and SCAMPI, benchmark discipline and progress on process improvement, and establish systems and software engineering and project management maturity. SCAMPI refers to appraisal methods used in the CMMI models.

Comprehensive Performance Management

Components of category two, comprehensive performance management include use of PerformanceAwardManager to maintain, trend and display performance metrics, Professional Review Individual Development and Evaluation (PRIDE) system, and contract deliverables.

PerformanceAwardManager includes comprehensive, monthly performance assessment against contract-defined performance metrics through elements such as: flexible evaluation schema provides more detailed insight; category weighting matches scoring to client key interests; scoring supported by comments/attachments; program quality performance achieved through identification of deficiencies at the lowest measureable level; displays of actual project and selected program subset roll-up scores provide insight to key functional areas over the period of performance; and graphing and tabular displays allow for trending analysis.

Client involvement and oversight includes collaboration on design of organizational structure that meets clients functional and management needs; involvement in performance measurement development; input to monthly performance assessment; and client visibility into system promotes deficiency identification.

Elements of PRIDE include establish measurable performance baseline for Entity team members and subcontractors; quarterly evaluations promote refinement of performance objectives to meet emerging and changing client needs; address performance issues and areas of improvement; and helps manager review resource allocation to change performance objectives, if necessary, to meet contract deliverables.

Elements contract deliverables include: details are recorded and tracked at the lowest level to ensure complete understanding and compliance; allows for auditing of deliverables against contract requirements; automatic escalation email notification to senior management if deliverables are not met; and filtering features allow detailed view into deliverables schedule for prioritization of task assignments.

Quality Assurance Validation and Escalation

Components of category three, quality assurance validation and escalation include internal audits by Entity quality assurance department, and problem identification and escalation Process.

Elements of internal audits include scheduled formal audits result in an objective evaluation of process and project performance; and audits identify trends, lessons learned, corrective/preventative actions and prioritization of improvement efforts across the organization.

Elements of problem identification and escalation process include: raises issues, actions or concerns to a higher-level of management for resolution when it cannot be reached at the lower levels; and incremental escalation process comprising four steps: identification and notification of escalation, joint escalation discussions, escalation to higher level (if necessary), and resolution and closure.

Comprehensive Risk Management

Components of category four, comprehensive risk management include PIMS, The project management assessment tool/PerformanceAwardManager, customer feedback reports, financial reports, and corporate-level project/program reviews.

FIG. 26 shows an exemplary risk management user interface in accordance with the present disclosure. In particular, FIG. 26 shows a report of risk items including details such as status, assigned to, title, assessment score, probability of occurrence, consequence of occurrence, risk category and effect of management plan.

FIG. 27 shows an exemplary controlled library user interface in accordance with the present disclosure, including a controlled library of documents having a user interface providing document control functions such as check-out, check-in, last modified by, time spent, and the like.

FIG. 28 shows an exemplary performance objective user interface in accordance with the present disclosure, in which performance objectives are listed along with accompanying details such as title, category, sub category, date author, planned value, actual value and comments.

FIG. 29 shows an exemplary project audit checklist user interface in accordance with the present disclosure, including document control function similar to those described above for FIG. 27. FIG. 30 shows an exemplary contract deliverables requirements user interface in accordance with the present disclosure, including document control function similar to those described above for FIG. 27. FIG. 31 shows an exemplary delivered progress report user interface in accordance with the present disclosure, including document control function similar to those described above for FIG. 27.

PIMS provides a primary Entity portal for project documentation and corporate processes. Elements/attributes include: hosts all Entity management applications; dedicated location for program and project level documentation including: risk register, performance objectives, quality control, and work products; storage of performance metrics and lessons learned; and primary data source for Quality audits (Internal, ISO, CMMI). Varying applications are provided through PIMS. For example PIMS provides Entity approved process descriptions and procedures, templates and forms; a controlled library, performance objectives, project audit checklist, contract deliverable requirements and delivered progress reports. PIMS is globally accessible and continually updated. The PIMS risk items application provides the following further elements/attributes: risks captured and managed from identification through closure, tracks risk, probability, and consequences, encourages priority assessment of all risk items, allows assignment of responsibility for individual risk items, facilitates PMs and management working collaboratively with the client on risk items, and serves as a repository for previously identified and closed risk items.

FIGS. 32-33 show an exemplary risk items user interface in accordance with the present disclosure. FIG. 32 shows an exemplary risk management user interface in accordance with the present disclosure. In particular, FIG. 32 shows a report of risk items including details such as status, assigned to, title, assessment score, probability of occurrence, consequence of occurrence, risk category and effect of management plan.

FIG. 34 shows an add new risk item user interface having elements for specifying details of a risk item such as title, status, priority, probability of occurrence, consequence of occurrence, assigned to, planned closure date, description, potential impact, mitigation plan, date closed, basis of closure, risk category, effect of mitigation plan, related issues and comments.

FIG. 34 shows an exemplary management visibility user interface in accordance with the present disclosure. FIG. 35 shows an exemplary management view of assessment scores user interface in accordance with the present disclosure.

Elements/attributes of customer feedback report include: improving project performance is verified through customer feedback; improvement initiatives required at least twice a year; opportunity for client input on initiatives; and client and PM reach consensus on root cause and corrective actions for deficiencies.

In one embodiment Customer Feedback Report module encompasses Windows SharePoint Services 2.0 (under SharePoint Portal Server 2003), Microsoft office InfoPath 2003, Windows Server 2003, Net Framework Version 1.1, and Language: C#.NET.

The system steps can be as follows: 1/user logon to the share point portal server site and click on the Programs Area. Sub site List (Project List) will be displayed. Click on Client Feed Back library. Client feedback documents will be listed for the Project. The project manager can create or edit the document. The client can edit the document; he can not create. The project manager creates a document to fill a self assessment form. The client opens the same form previously created by the project manager and provides his/her own comments. The project manager will click the new document button from the Share point portal library, new document opens in the following in the Office InfoPath 2003. Assessed elements can include: customer satisfaction, technical performance, quality, schedule, cost control, personnel, accommodating changes/priorities, techniques/practices, business management, and delivering value to customer.

All inputs can be captured and stored. A button or hot link for each category can link to a history of prior scoring history such as previous three months. Navigational links are also provided e.g. top of the page. The module allows for linking of attachments. A user can also input a corrective action plan. In this case the default data can pre-load reducing the level of entry required. Such default data can include: previous month corrective action plan's which are not yet completed, and in the current month, categories for which client has rated less than 5 in the feed back. The project manager can modify all the columns except Client comments until the form is submitted as complete. Client can modify status and client Comments. When the Project Manager has completed the form and pressed the submit button the module asks for confirmation as to whether the Project Manager is done or whether he/she wants to modify again later. The form is saved, and if the Project Manger is done with the form, related confirmation emails are sent. After this time the data is not modified.

Similarly, the Project Manager provides input to the Client Feedback screen, confirming as to whether the Project Manager is done or whether he/she wants to modify again later. The form is saved, and if the Project Manager is done with the form, related confirmation emails are sent. After this time the data is not modified. The module can provide that the manager receives a mail notification to complete the previous month's feedback on a set date every month. The mail should continue on periodic basis (with reminder number) until task is completed. If the task is not completed by a set date this can be escalated such that a mailing also goes to the manager supervisor. Saved data can be used to generate a customer satisfaction trend report.

FIG. 36 shows an exemplary self assessment and client feedback report in accordance with the present disclosure. In particular, the report shows category, self feedback and client feedback for each category.

FIG. 37 shows exemplary detailed evaluation criteria in accordance with the present disclosure, including category and factors. FIG. 38 shows an exemplary root cause analysis report in accordance with the present disclosure in which items rated 5 that will be further improved by planned initiatives. FIG. 39 shows an exemplary management self assessment and customer feedback report in accordance with the present disclosure including division VP report.

FIGS. 40-41 show exemplary financial reports in accordance with the present disclosure. Elements/attributes of financial reports include instant access to project financials for immediate evaluation/estimation; detailed view of financial information available for comparison against projected burn rate; validation of charges (appropriate and in accordance with the contract) and allows data migration for trending and analysis.

FIG. 42 is a block diagram of a comprehensive risk management method in accordance with the present disclosure. Elements/attributes of Entity level project/program reviews include: monthly COO/DVP/QA review of each project within division to review customer satisfaction and project compliance with QMS, ensure proper level of management visibility into potential risks, and ensure timely management involvement; quarterly project status review given by project manager to COO/DVP/QA to address customer satisfaction, project performance and contract status and allow project manager presentation of risk issues directly to senior management; semi-annual project managers' meeting to allow formal training on policies, procedures and systems, information exchange on best practices, and review and address systemic risks.

As to the quarterly project status review given by project manager to COO/DVP/QA, the program and project reviews are conducted by the respective Program/Project Manager and include the following: client organization, review of recent Self Assessment Customer Feedback Reports, review of recent project management assessment tool assessments, project scope and vision, project continuity plan, project significant events, client new business development, and new business relevance. An organizational chart is created for each project illustrating client, Entity and subcontractor stakeholders. The customer feedback reports are reviewed to provide senior management with a complete understanding of recent activities, initiatives, corrective actions and level of client satisfaction. Project management assessment tool assessments detail project compliance with Entities quality management system. The project scope and vision table identify tasks currently being accomplished as well as potential new tasks or expansion of effort that can be included in the future. Outlook for current work contains concise and accurate descriptions of what is included in the project and how it will be managed. The project continuity plan describes both short term plans for the follow-on execution of contract options and funding and long term plans for winning a re-compete. The project significant events table presents significant events or accomplishments that have occurred within the previous quarter. Comments can be either positive or negative elaboration or feedback from the client. Client New Business Development table identifies new business opportunities and anticipated future opportunities that may become available within the current agency the project now supports. This is to ensure that staff members are proactively working to identify new opportunities for growth. New Business Relevance Table identifies those new business targets and anticipated opportunities the capture of which will be substantially enhanced by the work done under this project. Semi-annual project managers' meeting agenda provides: senior management presentation of strategic goals, direction and general corporate status; project presentations detailing scope, objectives, lessons learned and best practices; corporate training on new processes, systems and quality initiatives; and break-out sessions designed to solicit PM feedback on specified meeting themes through team dynamics.

FIG. 43 is a diagram of a comprehensive risk management stakeholder organization chart in accordance with the present disclosure showing a Job Status report, showing an exemplary customer, U.S. Department of Homeland Security, and an exemplary organization chart of executive management.

FIG. 44 is a diagram of a comprehensive risk management customer feedback report in accordance with the present disclosure. In particular, a project assessment summary includes a display showing categories and color-coded assessment values.

FIG. 45 is an exemplary comprehensive risk management project compliance user interface in accordance with the present disclosure. In particular, a project scope and compliance template is shown having fields for current work scope, outlook for current work, new work vision, action plan and status.

FIG. 46 is an exemplary comprehensive risk management project scope and vision user interface in accordance with the present disclosure. In particular, a project continuity plan template is shown including fields for period of performance, funding, action plan, status, termination date, work continuity plan and status.

FIG. 47 is an exemplary comprehensive risk management project significant events user interface in accordance with the present disclosure. In particular, a project significant events report summary is shown including fields for significant event or accomplishment and comments.

FIG. 48 is an exemplary comprehensive risk management client new business development user interface in accordance with the present disclosure. In particular, a client new business development table template is shown having fields for target name, scope of work or anticipated need, discovering method, anticipated value and RFP date.

FIG. 49 is an exemplary comprehensive risk management new business relevance user interface in accordance with the present disclosure. In particular, a new business relevance table template is shown having fields for target name, scope of work overlap with current project and RFP date. FIG. 50 is an exemplary comprehensive risk management meeting agenda in accordance with the present disclosure.

Institutionalized Performance Improvement Processes

Components of category five, institutionalized performance improvement processes include the continuous performance improvement partnership plus (CPIP+) program, corrective and improvement action plan, awards program, and project management assessment tool/PerformanceAwardManager.

Elements/attributes of continuous performance improvement partnership plus include: top-down development of performance improvement initiatives with input from project level; personnel activities are scheduled, monitored and tracked in PIMS; individual contributions are evaluated through PRIDE; and client evaluates progress through Customer Feedback Report. Benefits include: year-over-year performance improvement on all projects; delivers value in excess of contractual requirements; program involves all levels of Entity hierarchy; and initiatives are performed outside of contract funding.

FIG. 51 is a block diagram of the timeliness and oversight features of the continuous performance improvement system in accordance with the present disclosure. The management approach for CPIP+ includes in the contract first year: establish contract performance baselines; seek out complete understanding of client mission objectives; train team members on corporate quality and CPIP methodologies and values; develop and implement the first performance improvement plan. The management approach for CPIP+ includes in the contract second and subsequent years: evaluate the success of the first year's plan in adding value to contract; develop and implement the next annual performance improvement plan; and recognize team member performance and contribution to the plans achievement.

Exemplary roles related to the CPIP+ include the following: Entity Contracting Office provides a check and balance system on contract deliverables. The Chief Operating Officer (COO) provides full implementation of the CPIP+ approach through contract deliverables and provides quality assurance analyses and adherence to policies and procedures. Division Vice Presidents (or similar) ensure appropriate and achievable improvement recommendations, offer consistent understanding of deliverables for all team members, ensure deliverables match team members performance objectives, and monitor progress of initiatives and recommend corrective actions. Project Managers allocate necessary resources, apply quantitative improvement objectives for each team member, involve the client in the CPIP+ process, and report status of initiatives. Team Members thoroughly understand their projects' role and their role in relation to the client's mission, must comprehend how their performance will be measured, appreciate the use of PQATMMP, and know how they will implement the improvement initiatives. Chief Executive Officer (CEO) is program sponsor and final approver on each CPIP+ initiative, establishes the corporate framework, and ensures adequate resources are available to meet the mission objectives that lead to increased value to the for the clients.

The corrective and improvement action plan is a key component of the Customer Satisfaction Assurance Process, deficiencies and improvement initiatives are recorded and discussed with the Client. This action plan conducted monthly in conjunction with the Self Assessment and Customer Feedback Report; provides a means for Client collaboration and concurrence on development of root cause determination and Entity improvement initiatives. Failure to complete activities by the stated due dates results in an escalation to Entity quality assurance and senior management.

The corrective action plan applies to all categories on the Self Assessment and Customer Feedback Report which receive a score lower than 5 or for which Client expressed concern or disagreement. In practice, Entity Manager and Client develop root cause for deficiency; corrective action is developed jointly; and the action is tracked to closure. Benefits of the corrective action plan include: collaboration increases likelihood of properly identifying suitable correction action; and documentation is essential for both audit and process improvement purposes.

Related to the improvement action plan: each project is obligated to implement improvement initiatives; performance improvements must be measurable and evident to the Client; and annual performance improvement plan as required by CPIP+ is recorded and tracked through this form. Benefits of the improvement action plan include: initiatives are generated by members throughout the Entity hierarchy, providing varied improvement perspectives unique to the individual's expertise; adheres to improvement requirements as directed by ISO, ITIL and CMMI standards; and Client monitors and acknowledges initiative as a value-added achievement.

Elements/attributes of Recognition and Awards include: formal recognition of measurable and client-recognized performance improvement and value-added service—for example awards banquet includes peers, Entity and Client management and awardees receive a plaque and a check; semi-annual program is open to all project staff (Entity and subcontractor); and projects are assessed on percentage of staff meeting award performance requirements. Benefits of Recognition and Awards include: staff understanding of Entity and Client objectives and expectations; incentivizes staff involvement towards the accomplishment of Entity-defined performance objectives; and engages staff to consider value contribution towards the client mission objectives.

Engage and Empower Team

The engage and empower team value possibility provides possibilities to continually improve the organization; establish expectations as opportunity objectives to maximize team effectiveness; effectively bring all team members/stakeholders into a participatory role; encourage and reinforce creativity to continuously improve all aspects of performance; achieve a synergistic team environment to collectively deliver maximum value to the program; and define and achieve individual enhancement requirements over the life of the project.

The engage and empower team value possibility includes four categories. These include: 1/Systematic Performance Objectives Definition and Review; 2/Recognition and Awards; 3/Professional Development Resources and Support; 4/Industry Leading ‘Other’ Benefits, and 5/Special Incentive Programs.

Systematic Performance Objectives Definition and Review

Components of category one, Systematic Performance Objectives Definition and Review include: performance requirements, professional development, and established process (PRIDE). The Performance Requirements are the five most critical job elements. These elements are considered the most important requirements for a position, they provide the standards that will be used to qualify potential candidates, they are based on contract deliverables and they serve as a foundation for evaluating team members quarterly.

Team member development or professional development gives the team member an opportunity to have a dialogue with the President's Office to review their goals and objectives. Meetings occur twice a year. Confidential information is kept between human resources and the CEO. Areas of emphasis include: 1/What does the corporation need to do beyond what is already being doing to be supportive of your success in exceeding your Critical Job Elements (CJE's); 2/How can the company support you in increasing your skills?; 3/If you have the desire to increase your income and your present position does not provide that opportunity, what other type of work would you like to do in the company that will provide that opportunity to earn a higher income?; 4/What is the training and experience that you need to have in order to qualify to perform on the desired job?; 5/Regarding your own and your family's roles and objectives, is there anything where the company may be able to assist you?; and 6/Is there any other topic you want to discuss?

Professional Review Individual Development and Evaluation System (PRIDE) assesses and tracks the continuous professional growth and development of our technical and administrative staff. This system ties Team Member assignment, goals and development to their role on a project. Focuses management attention on the team members' contributions.

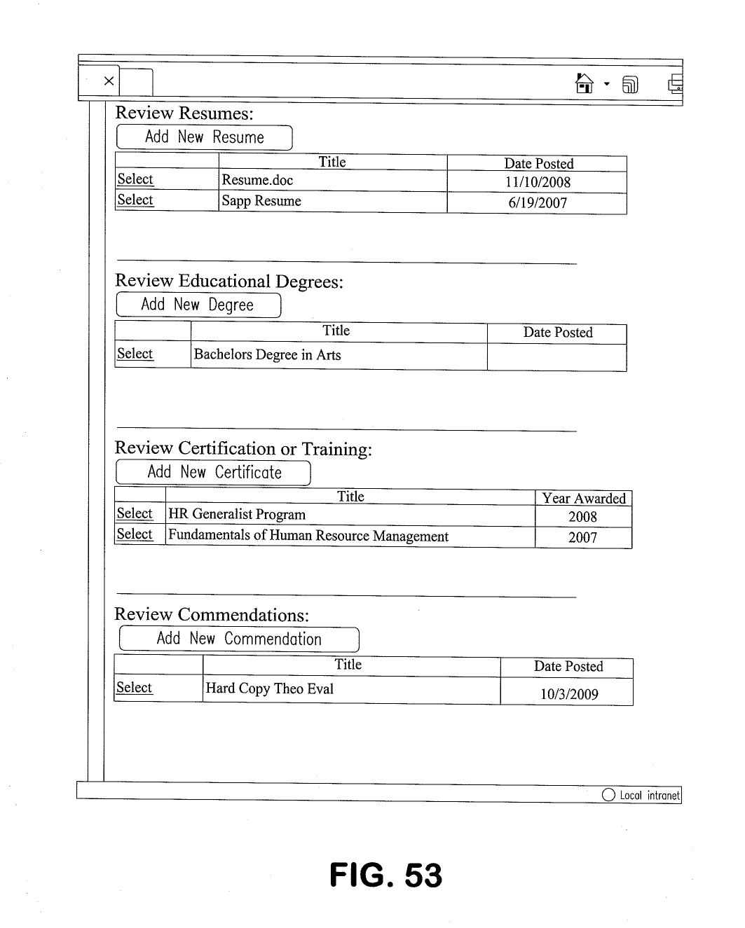

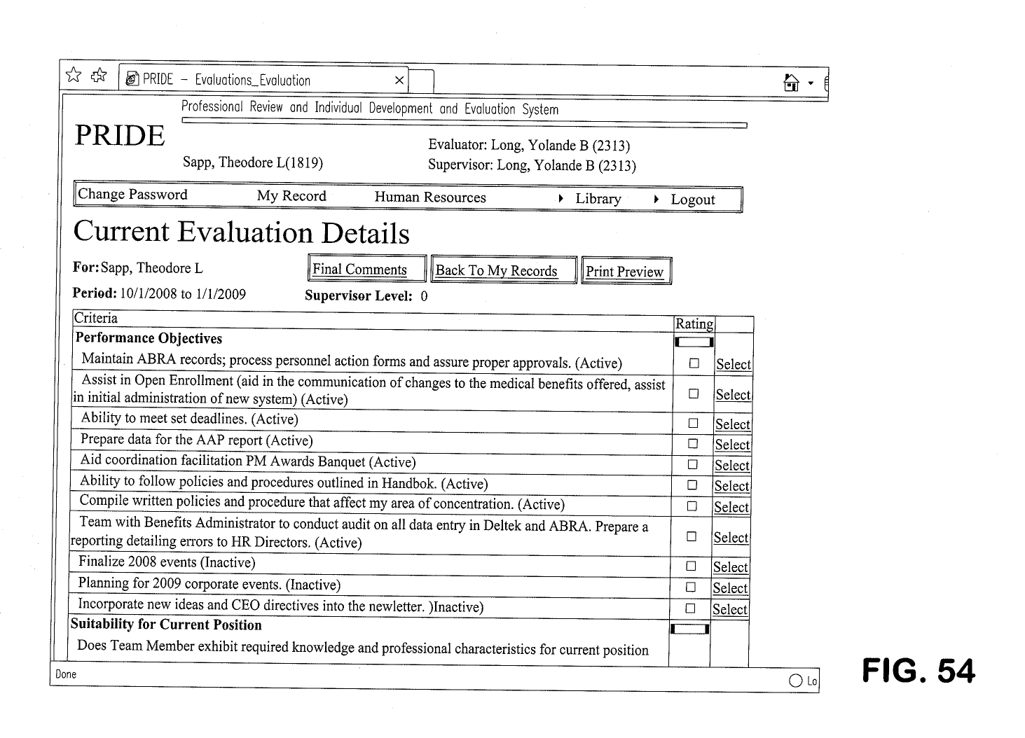

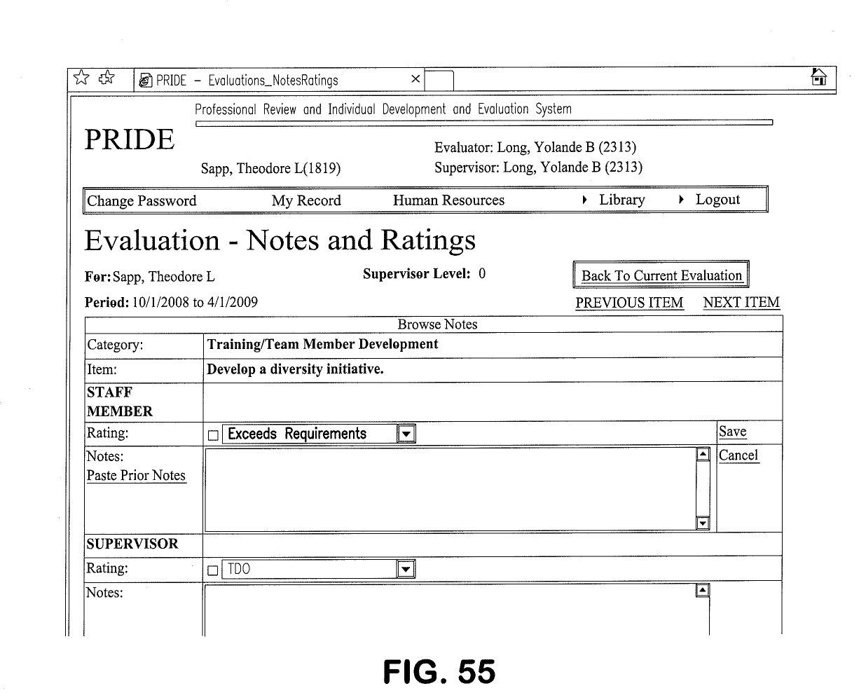

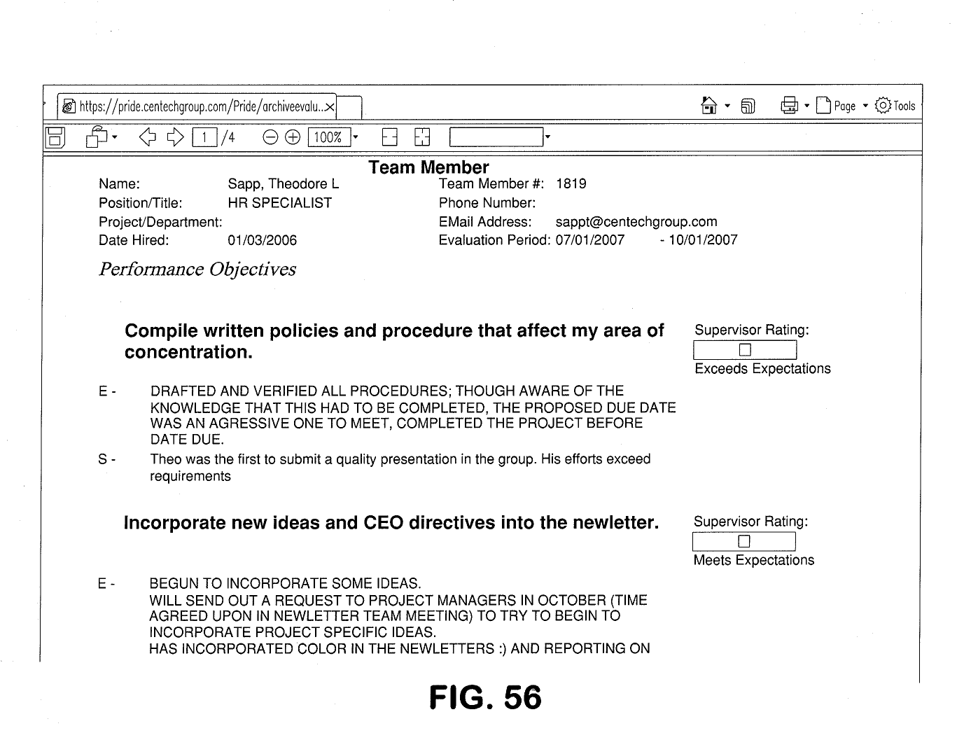

FIGS. 52-56 show exemplary individual development and evaluation system user interfaces in accordance with the present disclosure. FIG. 52 shows an exemplary user interface for performance evaluations. FIG. 53 shows an exemplary user interface for adding information to an employee profile such as resume, educational degrees, certifications or training and review commendations. FIG. 54 shows an exemplary user interface screen for current evaluation details such as evaluation criteria and rating with user interface elements to select and add a rating. FIG. 55 shows an exemplary user interface screen for evaluation notes and ratings in which user interface elements permit input of ratings and notes. FIG. 56 shows an exemplary evaluation report listing details of an evaluation.

Recognition and Awards

Components of category two, Recognition and Awards include: process improvement/productivity, leadership, innovation, client recognition, professional development, and mature process and history of Entity commitment. Recognition and award is a Semi-annual awards program designed to appeals to every Entity Team Stakeholder. Consideration is based on a team member exceeding their position's requirements. The awards program is available to all team members who have been employed for a minimum of six months. The program consists of: award categories, focusing on critical areas that ensure customer satisfaction, nominations made by clients, managers, and self nominations by team members; recognizing the partnership between ENTITY, team members, subcontractors and clients. Examples of awards include process improvement/productivity, leadership, innovation, CPIP Award, client recognition and professional development.

Elements within a process improvement/productivity award include: identification and successful implementation of an improved process or technique; lead to an increase of a least five (5) percent in productivity or a reduction of greater than one (1) percent in cost; recognizes efforts resulting in measurable improvements in cost and schedule against the documented baseline in the project's work breakdown structure (WBS); result is a significant improvement in performance, schedule, cost, quality, contract expansion or customer satisfaction and does not sacrifice existing commitments, quality or safety to the customer or the corporation.

Elements within a leadership award include: leading an effort that resulted in an increase of at least five (5) percent in productivity o a reduction of greater than one (1) percent in cost; demonstrated when an individual in a team environment provides influence, direction or guidance; results in significant improvement in performance, schedule, cost, sales and profit; product of the team member's actual management of others to delivery of an objective and includes a documented proposal of the nominee's plan and actions and measurable objective of the achievement.

Elements within an innovation award include: identification and successful implementation of a solution or system; leading to an increase of at least five (5) percent in productivity or a reduction of greater than one (1) percent in cost; innovation in the use of a device, tool or technology; results in significant improvement in performance, schedule, cost, quality, and contract expansion or customer satisfaction; does not sacrifice existing commitments, quality or safety to the customer or the corporation; and contributes to the project or task, or to the achievement of the client's mission goals and objectives.

Elements within a continuous performance improvement partnership award include: generating continuous performance improvement initiatives; initiative must have been pre-defined by Entity's project team; client recognition as a significant performance-improving initiative; specifically relates to one or more client or Entity-defined performance objectives; cannot be part of existing project or contract requirements or commitments; and result is an increase of at least four (4) percent in productivity or a reduction of greater than one (1) percent in cost.

Elements within a client recognition award include: formal commendation from a client for a specific achievement; recognition is beneficial to both the individual and Entity's reputation for excellence; received for specific accomplishment resulting in a benefit to the client; and evidence of customer acknowledgement of the team member's achievement.

Elements within a professional development award include: 1/individual achievements of team members such as publishing a book, article or paper in a professional forum, chairing a professional conference, noteworthy achievement by a professional organization, or professional/academic credit/certification through examination by an authorized organization; 2/training must enhance qualifications within a respective professional community; 3/further the reputation of Entity or the quality and value of the services and products we deliver to our customers.

Professional Development Resources and Support

Components of category three Professional Development Resources and Support include: Entity University and PIMS, training and certification, educational assistance, team member service support center (TMSSC), and long-standing Entity record of commitment.

Entity University is an online educational resource center that houses real-time self-paced learning instruction on various processes and seminars as well as instructor guides for various workshops. It serves as an approved corporate reference library. PIMS—Project Information Management Systems is an online corporate reference library for policies, procedures, templates and forms. In addition, it also serves as the main communication gateway of contract deliverables and access to the Deltek timekeeping and Team Member Support Service Center applications.

Educational assistance is provided related to professional development courses; self-development certification programs; company-directed training; and team member requested training.

Professional development courses are independent course work that is not in pursuit of a degree, is related to the team member's Entity position, and will enhance the team member's potential for advancement within the Entity. These courses are reimbursed at a rate of 50% of the cost of the course, applicable fees and course material; and should result in a grade or certification of completing the topic. Examples include AMA Management Courses and ASTD Online courses,

Related to self-development certification programs the development should result in formal certification of professional proficiency and the program is 100% company paid (material cost and the fee for the certification examination). Examples include Microsoft Certified Network Engineer (MSNE), and Project Management Professional (PMP), A+.

Related to company-directed training the training should be an Entity requirement for the position. The Entity will pay 100% of the cost of the training. Examples include: Preparing for Leadership, Oracle Application, and Sharepoint

Related to team member requested training (Tuition Reimbursement/Educational Assistance) the training should be toward the pursuit of an undergraduate or graduate degree (B.A., B.S., M.A, Ph.D). The coursework should be relevant to the team member's current position and future contribution. Reimbursement is up to 85% of course work, with a maximum of $2000 per year to include: costs, tuition, applicable fees, and course material. Team Members are reimbursed based on the grade. For example, a grade of “A” receives an 85% reimbursement, a grade of “B” receives a 70% reimbursement, a grade of “C” receives a 50% reimbursement, and pass/fail is reimbursed 85% for a passing grade and 0% for a failing grade.

Team Member Service Support Center (TMSSC) is a 24/7 web-based resource management system that allows team members to make online requests from entity staff. The center provides increased accountability and responsiveness to Team Member requests for Technical, human resources, accounting, or quality assurance assistance. Such needs can relate to technical support such as Email, hardware, software, internet, intranet; human resources such as 401K plans, educational assistance, orientation, payroll; and/or administration such as documents (printing/copying), meeting rooms, office supplies, parking (passes/info), projectors/presentation equipment, purchasing, telephone/voicemail.

FIG. 57 shows an exemplary service support center user interface in accordance with the present disclosure. In particular, the service support center can provide user interfaces for the creation, tracking, working and reporting of trouble ticket or support request items.

One of the best ways to retain talented and motivated employees is to strengthen their ties to their profession/career. Through industry-recognized memberships, conferences and opportunities for continuing education, team members take ownership and enhance their own ability to thrive. Long standing Entity record of commitment therefore relates to opportunities for and compensation of professional memberships, continuing education, and networking through conferences.

Industry Leading ‘Other’ Benefits

Components of category four, Industry Leading ‘Other’ Benefits include health and wellness, and financial component. Examples of health and wellness benefits include Provide and abide by a healthy mission statement; health, dental and vision coverage; life insurance, AD&D, short-term disability, long-term disability, flexible Spending Account and Combined Plans, long-term care, credit union, and online enrollment system. Examples of financial benefits include 401K with match $1:$1 up to three percent of income and match 0.50: $1 up to 7.5 percent of income—and with three year upward scale vesting period.

Special Incentive Programs

Components of category five, Special Incentive Programs include self designated bonus program, and entrepreneur assistance program. Major incentive programs motivate team members financially and professionally during their tenure with the company. This continuous challenge to do ‘more’ gives an added level of authority and an emphasis on personal, professional and organizational improvement. Program examples include: self designated bonus program, employee referral bonus program, management development program, SPOT program, service awards, entrepreneur assistance program, and around the world challenge.

The self designated bonus program has three main areas of focus. First, proposals submitted by Team members to the Entity Executive Committee. The projects are above and beyond the scope of their normal duties. The projects are completed outside of normal work hours. Second, team members make the initial determination of the monetary value. There is an understanding is that the work must benefit Entity and must improve services to the client or company. Third, once a team member receives approval from the Executive Committee work can begin and once it is successfully completed the Team member receives the self-designated bonus.

The entrepreneur assistance program demonstrates commitment to supporting long-term financial growth and professional career goals of Team members. The objective is to provide a significant and unique opportunity to Team members who have contributed to Entity's success. The program is offered to team members who have served a minimum of five years and are in good standing. Team members can achieve the dream of owning their own business. The Entity's Role is to serve as a mentor to assist the new firm with specific business strategies, technical assistance in the development of policies, procedures, and other necessary management assistance, business counseling, and the establishment of financial credit.

The Employee Referral Bonus Program is open to all Team Members and is a standard referral amount awarded when a Team members refer colleagues, friends, etc. who meet the published qualifications and criteria.

SPOT Awards or a Spot Bonus recognizes specific accomplishments that are: in the interests of the company and the client, monetary awards made on-site within three days of the accomplishment and are formally recognized at an Awards Banquet.

Management development program provides an opportunity to develop practical and sophisticated expertise in a wide range of company functions. Team members can design their own management career paths with the company. The Program's objective is to “grow” a professional who, during the course of the program will: learn effective management of people, projects, and functions; gain familiarity with all corporate operations and departments; increase the skills and knowledge required to be a manager in the company; have been trained extensively in Entity's management style; and understand the company's vision, goals, and objectives.

The Trip around the world challenge is a means of identifying benefits offered by other organization by providing a challenge to any team member to identify any commercial or private sector organization that has offered the following four programs to employees in the last two (2) years: PQATMMP—Productivity and Quality Assurance Team Member Motivation Program; Team Member Development Program; Self-Designated Bonus Program; and Entrepreneur Assistance Program.

Special awards include honoring Team Members starting at one-year of service, then in intervals of 3, 5, 10 and 15 years. The awards include jeweled lapel pins since genuine jewels and diamonds have long been the international symbol of quality and relationships

The awards team members receive are tangible, long-lasting high quality products and serve as reminders of the value that Entity has on the Team Member's service and contributions as well as symbols of pride and appreciation.

FIG. 58 is a block diagram showing an exemplary team member incentive and development program in accordance with the present disclosure. In particular, the program can include defining and reviewing systematic performance objectives, providing professional development resources, providing incentive programs, providing benefits, and providing recognition and rewards.

Having now described a few embodiments of the invention, it should be apparent to those skilled in the art that the foregoing is merely illustrative and not limiting, having been presented by way of example only. Numerous modifications and other embodiments are within the scope of one of ordinary skill in the art and are contemplated as falling within the scope of the invention and any equivalent thereto. It can be appreciated that variations to the present invention would be readily apparent to those skilled in the art, and the present invention is intended to include those alternatives. Further, since numerous modifications will readily occur to those skilled in the art, it is not desired to limit the invention to the exact construction and operation illustrated and described, and accordingly, all suitable modifications and equivalents may be resorted to, falling within the scope of the invention.

What is claimed is:

1. A system for continuous performance improvement, the system comprising:
a web-based workspace module adapted to provide visibility of project documentation and to provide collaboration and version control for the project documentation, the web-based workspace further adapted to provide a corporate portal;
a project performance management module adapted to provide an assessment of current project performance against project-unique performance metrics;
a contract deliverable management module adapted to provide a report of project deliverables along with a delivery status of each project deliverable;
a financial reporting module adapted to provide financial reports representing project financial status;
a customer satisfaction assurance module adapted to receive self assessment information and client feedback information related to performance on the project and to provide a report indicating customer satisfaction as represented by the self assessment information and the client feedback information.

2. The system of claim 1, further comprising a corporate experience database adapted to store corporate standards business rules, cost model business rules and staffing information.

3. The system of claim 1, further comprising a quality assurance module adapted to provide quality assurance oversight, quality assurance reporting and quality assurance approval of pending deliverables.

4. The system of claim 1, further comprising a repository module adapted for storage and retrieval of electronic process descriptions, procedures, templates and forms.

5. The system of claim 1, further comprising a risk items module adapted to capture an electronic record of risk items and to track each risk item from identification through closure, the risk items module further adapted to permit assignment of responsibility for each risk item and to provide a report of risk items.

6. The system of claim 1, further comprising a team member development and evaluation module adapted to store an electronic representation of professional growth and development information for each team member, the team member development and evaluation module including a user interface for team members and supervisors to input and review information relating to team member professional growth and development.

7. The system of claim 1, wherein the web-based workspace module includes a user interface adapted to provide continuous, real-time access to project data in electronic form.

8. The system of claim 7, wherein project data includes at least one of deliverables, project-specific work documents, project-specific templates, schedules, action assignments and status, risk management documents, performance objectives, quality plans and quality reports.

9. The system of claim 1, wherein the web-based workspace module is further adapted to provide time tracking of document locking and changing information corresponding to a document author and a document.

10. A computer-implemented method for continuous performance improvement, the method comprising:
providing visibility of project documentation and permitting collaboration and version control for the project documentation, via a web-based workspace module, the web-based workspace further adapted to provide a corporate portal;
managing project performance using a project performance management module adapted to provide an assessment of current project performance against project-unique performance metrics;
providing a report of contract deliverables using a contract deliverable management module adapted to provide a report of project deliverables along with a delivery status of each project deliverable;
providing financial reports using a financial reporting module adapted to provide financial reports representing project financial status; and
receiving self assessment information and client feedback information related to performance on the project at a customer satisfaction assurance module and providing a report indicating customer satisfaction as represented by the self assessment information and the client feedback information.

11. The method of claim 10, further comprising providing corporate standards, business rules, cost model business rules and staffing information from a corporate experience database.

12. The method of claim 10, further comprising providing quality assurance oversight, quality assurance reporting and quality assurance approval of pending deliverables using a quality assurance module.

13. The method of claim 10, further comprising storing/retrieving electronic process descriptions, procedures, templates and forms to/from a repository module adapted for storage and retrieval.

14. The method of claim 10, further comprising capturing an electronic record of risk items at a risk items module and tracking each risk item from identification through closure, the risk items module further adapted to permit assignment of responsibility for each risk item and to provide a report of risk items.

15. The method of claim 10, further comprising storing, at a team member development and evaluation module, an electronic representation of professional growth and development information for each team member, the team member development and evaluation module including a user interface for team members and supervisors to input and review information relating to team member professional growth and development.

16. The method of claim 10, wherein the web-based workspace module includes a user interface adapted to provide continuous, real-time access to project data in electronic form.

17. The method of claim 16, wherein project data includes at least one of deliverables, project-specific work documents, project-specific templates, schedules, action assignments and status, risk management documents, performance objectives, quality plans and quality reports.

18. The method of claim 10, wherein the web-based workspace module is further adapted to provide time tracking of document locking and changing information corresponding to a document author and a document.

19. A computer-readable medium having software instructions stored thereon, the software instructions, when executed by a processor, cause the processor to perform operations comprising:
providing visibility of project documentation and permitting collaboration and version control for the project documentation, via a web-based workspace module, the web-based workspace further adapted to provide a corporate portal;
managing project performance using a project performance management module adapted to provide an assessment of current project performance against project-unique performance metrics;
providing a report of contract deliverables using a contract deliverable management module adapted to provide a report of project deliverables along with a delivery status of each project deliverable;
providing financial reports using a financial reporting module adapted to provide financial reports representing project financial status; and
receiving self assessment information and client feedback information related to performance on the project at a customer satisfaction assurance module and providing a report indicating customer satisfaction as represented by the self assessment information and the client feedback information.

20. The computer-readable medium of claim 19, wherein the operations further comprise capturing an electronic record of risk items at a risk items module and tracking each risk item from identification through closure, the risk items module further adapted to permit assignment of responsibility for each risk item and to provide a report of risk items.
